(19) United States
(12) Patent Application Publication
(10) Pub. No.: US 2025/0018776 A1
(43) Pub. Date: Jan. 16, 2025

(54) TRI-FOLD TONNEAU COVER

(71) Applicant: Peragon Enterprises, Inc., Shell Lake, WI (US)

(72) Inventors: Heath Copp, Trego, WI (US); Cory Robinson, Shell Lake, WI (US)

(21) Appl. No.: 18/769,889

(22) Filed: Jul. 11, 2024

Related U.S. Application Data
(60) Provisional application No. 63/526,028, filed on Jul. 11, 2023.
(60) Provisional application No. 63/535,638, filed on Aug. 31, 2023.

(51) Int. Cl. B60J 7/04; B60J 7/00; B60J 7/19

(52) U.S. Cl. CPC B60J 7/042; B60J 7/0084; B60J 7/198

(57) ABSTRACT

A tri-panel tonneau cover arrangement comprising a first panel, a second panel, and a third panel. The second panel hingedly coupled between the first panel and the third panel and slidably coupled to a rail assembly within the truck bed, enabling the tonneau cover to transition between different configurations, such as a closed configuration where the panels are positioned in coplanar orientation to cover the truck bed opening, and a folded configuration where the panels are stacked atop one another. The rail assembly includes features that enable the panels to drop into detents, shifting the weight to a moisture-resistant seal between the panels and the truck bed. Additionally, the tonneau cover incorporates water collection channels to inhibit water intrusion along the hinged edges between the panels, thereby ensuring a reliable seal and enhancing functionality while reducing complexity and maintenance requirements.

### CROSS-REFERENCE TO RELATED APPLICATION

This application claims the benefit of U.S. Provisional Application No. 63/526,028, filed Jul. 11, 2023, and U.S. Provisional Application No. 63/535,638, filed Aug. 31, 2023, both entitled “TRI-FOLD TONNEAU COVER.” The disclosures of these applications are hereby incorporated herein by reference.

### TECHNICAL FIELD

The present disclosure relates generally to the field of pickup truck accessories, and more particularly to a retractable tonneau cover system for a truck box of a pickup truck.

### BACKGROUND

Pickup trucks typically include a pickup truck box positioned toward a rear end of the pickup truck and behind a cab of the pickup truck. The pickup truck box, as delivered from the factory, typically includes an opening behind a front wall of the pickup truck box and between a right and a left sidewall of the pickup truck box. At a rear end of the pickup truck box, an end gate is typically positioned between the right and the left sidewalls of the pickup truck box. The end gate is typically foldable to an open position that pivots about a horizontally oriented axis that is positioned adjacent to a bed of the pickup truck box. The front wall, the right and the left sidewalls, and the end gate of the pickup truck box typically extend upward from the bed of the pickup truck box. The opening of the pickup truck box typically extends around a perimeter of the pickup truck box and includes tops of the front wall, the right and left sidewalls, and the end gate. The opening of the pickup truck box allows the pickup truck box to haul irregularly shaped and large objects that may extend above the tops of the front wall, the right and the left sidewalls, and the end gate of the pickup. However, the opening of the pickup truck box does not provide enclosed storage that is often desired. Moreover, the opening of the pickup truck box may further create increased aerodynamic drag on the pickup truck, resulting in increased fuel usage.

A variety of pickup truck box covers have been developed and are available in the marketplace. These covers typically span the opening of the pickup truck box and extend around its perimeter. They are designed to either completely or substantially cover the opening and often include locking mechanisms to secure the cover in an extended position. Additionally, most pickup truck box covers can be converted into a retracted configuration, where the cover is folded or moved aside to expose the opening of the pickup truck box. In some cases, the cover can be completely removed from the pickup truck box, thereby making the entire space or almost the entire space available for use.

U.S. Pat. Nos. 6,321,819; 9,707,833; 9,296,285; 10,471,879; and U.S. Pat. No. 10,654,346 to Copp et al., describe retractable cover systems for use in covering the openings of pickup truck boxes. These patents, which detail various aspects of the retractable cover systems, are hereby incorporated by reference in their entirety. Peragon Enterprises, Inc., located in Shell Lake, Wisconsin, specializes in the sale of these retractable cover systems.

### SUMMARY

In general terms, the present disclosure is directed to a multifunctional and adaptable tonneau cover system designed to enhance the usability, security, and environmental resilience of truck bed covers.

According to certain aspects, the present disclosure is directed to a tri-panel cover arrangement that allows for versatile positioning, enabling the panels to be either laid flat in alignment or in a stacked configuration for access or storage purposes.

According to certain aspects, the present disclosure is directed to a hinge mechanism that raises pivot points above the panel surface, accommodating the panel thickness and facilitating smooth transitions between configurations.

According to certain aspects, the present disclosure is directed to the construction of the cover system from durable sheet metal, providing strength and longevity.

According to certain aspects, the present disclosure is directed to an inwardly bent bottom edge of a hinge edge, aimed at improving the rigidity and stability of the panel.

According to certain aspects, the present disclosure is directed to a specific height reduction of the hinge edge relative to other panel edges, creating an optimal gap for functionality and aesthetics.

According to certain aspects, the present disclosure is directed to a water collection channel on the second panel designed to manage and remove moisture effectively.

According to certain aspects, the present disclosure is directed to a water collection channel, which includes a hinge edge, channel bottom, and side wall, collectively facilitating efficient water management.

According to certain aspects, the present disclosure is directed to a placement of the water collection channel to intercept and redirect moisture away from the panel interface.

According to certain aspects, the present disclosure is directed to a rail assembly that supports the cover and also allows for sliding movement, enhancing the cover's adaptability to different truck bed requirements.

According to certain aspects, the present disclosure is directed to the incorporation of detents within the rail assembly, which serve to shift the cover's weight towards its edges, thus improving the seal against environmental elements.

According to certain aspects, the present disclosure is directed to the arrangement and spacing of rollers and detents, which ensures that the second panel can be securely positioned along the rail assembly as needed.

According to certain aspects, the present disclosure is directed to latch assemblies that enable secure attachment to a striker element, ensuring the cover remains in place during transit.

According to certain aspects, the present disclosure is directed to a striker element designed with flat surfaces to enhance the latch assembly's engagement and adaptability.

According to certain aspects, the present disclosure is directed to a linkage system that connects latch assemblies for simultaneous driver side and passenger side operation, simplifying the engagement and release process.

According to certain aspects, the present disclosure is directed to hinges that facilitate toolless removal of panels, allowing for quick and easy adjustments or removal of the cover system. Other aspects of the present disclosure are directed to hinges that require a tool, key or other mechanism to enable removal of the cover system.

According to certain aspects, the present disclosure is directed to tiedowns designed to maintain strap tautness, contributing to the overall security of the system.

According to certain aspects, the present disclosure is directed to the alignment of tiedowns across the panels, which ensures effective strap management, especially when the cover is in its folded configuration.

According to certain aspects, the present disclosure is directed to an interlock system featuring a resilient cantilever arm, which provides additional security by locking the second panel in place at various points along the rail assembly.

A variety of additional inventive aspects will be set forth in the description that follows. The inventive aspects can relate to individual features and to combinations of features.

It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a top perspective view of a tonneau cover, in accordance with an embodiment of the disclosure.

FIG. 2 is a bottom perspective view of the tonneau cover of FIG. 1.

FIG. 3 is a top plan view of the tonneau cover of FIG. 1.

FIG. 4 is a bottom plan view of the tonneau cover of FIG. 1.

FIG. 5 is a top perspective view of at least one of a first panel or a third panel of a tonneau cover, in accordance with an embodiment of the disclosure.

FIG. 6 is a bottom perspective view of the first or third panel of FIG. 5.

FIG. 7 is a perspective view of the first or third panel of FIG. 5.

FIG. 8 is a perspective view of a portion of the first or third panel of FIG. 5.

FIG. 9 is a close up, partial, perspective view of a portion of the first or third panel of FIG. 5.

FIG. 10 is a close-up, partial, perspective view the first or third panel of FIG. 5 mounted on a rail assembly.

FIG. 11 is a perspective view of a second panel of a tonneau cover, in accordance with an embodiment of the disclosure.

FIG. 12 is a top perspective view of the second panel of FIG. 11.

FIG. 13 is a bottom perspective view of the second panel of FIG. 11.

FIG. 14 is a perspective, cross-sectional view depicting a hinged coupling between a first panel and a second panel of a tonneau cover, in accordance with an embodiment of the disclosure.

FIG. 15 is a perspective, cross-sectional view depicting a hinged coupling between second panel and the third panel of a tonneau cover, in accordance with an embodiment of the disclosure.

FIG. 16 is a perspective view depicting a panel defining drain apertures.

FIG. 17 is a close-up, perspective view depicting the drain aperture of FIG. 16.

FIG. 18 is a partial, cross-sectional view depicting a tri-panel cover arrangement, in accordance with an embodiment of the disclosure.

FIG. 19 is a partial, cross-sectional view depicting the tri-panel cover arrangement of FIG. 18 in an alternate configuration, in accordance with an embodiment of the disclosure.

FIG. 20 is an exploded, perspective view depicting a hinge, in accordance with an embodiment of the disclosure.

FIG. 21 is a schematic view depicting toolless separation of a wing of the hinge of FIG. 20.

FIGS. 22A-F are profile views depicting a tonneau cover transitioning from a first, open configuration (as depicted in FIG. 22A) to a second, folded configuration (as depicted in FIG. 22E), in accordance with an embodiment of the disclosure.

FIG. 23 is a perspective view of a tiedown, in accordance with an embodiment of the disclosure.

FIG. 24 is a profile view of the tiedown of FIG. 23.

FIG. 25 is a front perspective view of the tiedown of FIG. 23.

FIG. 26 is a perspective view depicting a rail assembly, in accordance with an embodiment of the disclosure.

FIG. 27 is a perspective view depicting one side of the rail assembly of FIG. 26, in accordance with an embodiment of the disclosure.

FIG. 28 is a cross-sectional view of a clamp of a rail assembly, in accordance with an embodiment of the disclosure.

FIG. 29 is a close-up cross-sectional view of a rail assembly, in accordance with an embodiment of the disclosure.

FIGS. 30-32 are perspective views of the latch assemblies of a first panel of a tri-panel cover arrangement, in accordance with an embodiment of the disclosure.

FIGS. 33-34 are perspective views roller carriages of a second panel of a tri-panel cover arrangement, in accordance with an embodiment of the disclosure.

FIGS. 35-36 are, perspective views roller carriages of a second panel of a tri-panel cover arrangement, in accordance with an embodiment of the disclosure.

FIGS. 37-38 are perspective views depicting a roller carriage mounted to a rail assembly, wherein a roller of the roller carriage drops into a detent defined by the rail assembly, in accordance with a first embodiment of the disclosure.

FIGS. 39-40 are perspective views depicting a roller carriage mounted to a rail assembly, wherein a roller of the roller carriage drops into a detent defined by the rail assembly, in accordance with a second embodiment of the disclosure.

FIGS. 41-43 are perspective views of latch assemblies of a third panel of a tri-panel cover arrangement, in accordance with an embodiment of the disclosure.

FIG. 44 is a perspective view depicting alignment of a pair of bumpers with a pair of cut outs, enabling separation of a tri-panel cover arrangement from a rail assembly, in accordance with an embodiment of the disclosure.

FIG. 45 is a plan view depicting a tonneau cover design, in accordance with an embodiment of the disclosure.

FIG. 46 is a profile view depicting the tonneau cover design of FIG. 45.

FIG. 47 is an end view depicting the tonneau cover design of FIG. 45.

FIG. 48 is a perspective view depicting the tonneau cover design of FIG. 45.

FIGS. 49-50 are close-up, perspective views depicting corners of the tonneau cover design of FIG. 45.

FIG. 51 is a plan view depicting a tonneau cover design, in accordance with another embodiment of the disclosure.

FIG. 52 is a profile view depicting the tonneau cover design of FIG. 51.

FIG. 53 is an end view depicting the tonneau cover design of FIG. 51.

FIG. 54 is a perspective view depicting the tonneau cover design of FIG. 51.

FIGS. 55-56 are close-up, perspective views depicting corners of the tonneau cover design of FIG. 51.

FIGS. 57-58 are perspective views depicting a first hinge design, in accordance with an embodiment of the disclosure.

FIGS. 59-62 are side views depicting the first hinge design of FIGS. 57-58.

FIG. 63 is a plan view depicting the first hinge design of FIGS. 57-58.

FIGS. 64-65 are perspective views depicting a second hinge design, in accordance with an embodiment of the disclosure.

FIGS. 66-69 are side views depicting the second hinge design of FIGS. 57-58.

FIG. 70 is a plan view depicting the second hinge design of FIGS. 57-58.

FIGS. 71-72 are a perspective view of a tiedown design, in accordance with an embodiment of the disclosure.

FIG. 73 is a top view of the tiedown design of FIGS. 71-72.

FIG. 74 is a profile view of the tiedown design of FIGS. 71-72.

FIG. 75 is a top view of the tiedown design of FIGS. 71-72.

FIG. 76 is an end view of the tiedown design of FIGS. 71-72.

FIG. 77 is a bottom view of the tiedown design of FIGS. 71-72.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

### Overview

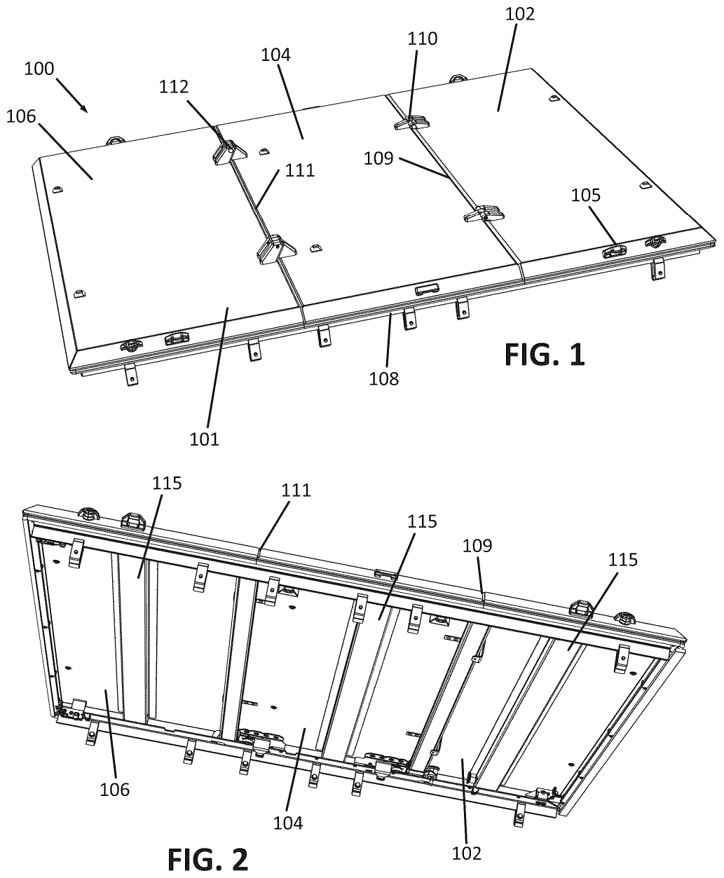

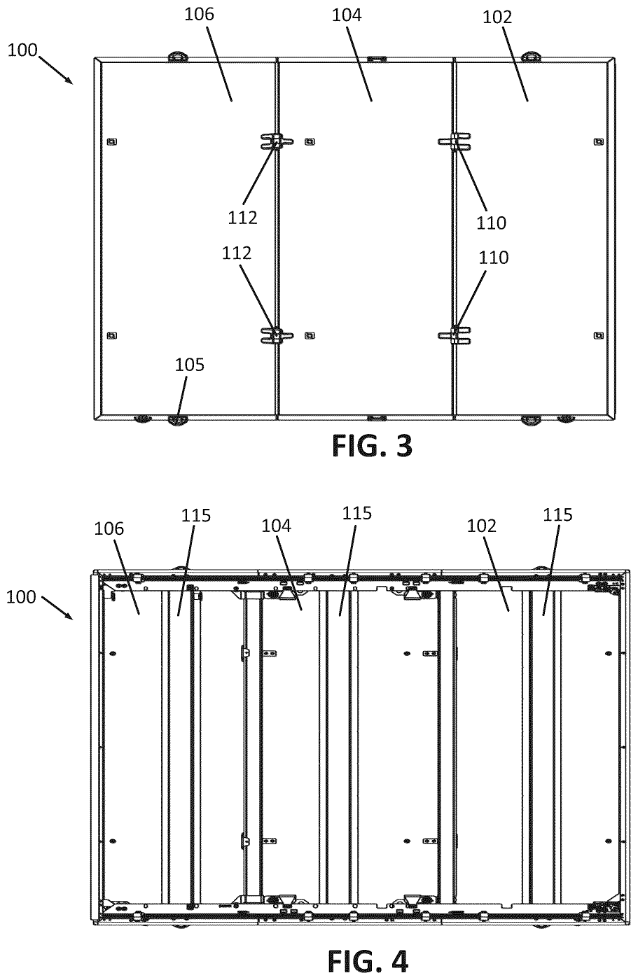

Referring to FIGS. 1-4, a tonneau cover 100 is depicted in accordance with an embodiment of the disclosure. In embodiments, the tonneau cover 100 can include three panels to form a tri-panel cover arrangement 101, including a first panel 102, a second panel 104 and a third panel 106. In embodiments, the first panel 102 can be positioned closest to a tailgate of the truck, the third panel 106 can be positioned closest to the cab of the truck, and the second panel 104 can be hingedly coupled between the first panel 102 and the third panel 106. Moreover, the second panel 104 can be slidably coupled to a rail assembly 108 secured within the bed of the truck, thereby enabling the tri-panel cover arrangement 101 to slide along the rail assembly forward and aft relative to the truck bed.

As will be described in further detail, during operational use, the tonneau cover 100 can transition between a number of functional configurations, including a first, closed configuration in which all of the panels 102, 104, 106 are positioned substantially coplanar to one another to cover the opening of the truck bed, and a second, folded configuration in which the panels 102, 104, 106 are stacked atop one another. Additional configurations are possible between these two states, including configurations where either the first panel 102 or the third panel 106 is folded to stack atop the second panel 104. In these configurations, the second panel 104 may either remain in its original position, occasionally referred to herein as the home position (the position along the rail assembly 108 where panel 104 resides in the first, closed configuration), or it may be shifted forward or aft along the rail assembly 108 relative to the truck bed.

### Features

The second panel 104, which can be operably coupled to the rail assembly 108 can be hingedly coupled to both the first panel 102 and the third panel 106, with the first panel 102 hingedly coupled to a first side 109 of the second panel 104 with one or more first hinges 110, and the third panel 106 hingedly coupled to a second side 111 of the second panel 104 with one or more second hinges 112. In the second, folded configuration, the second panel 104 can be positioned on the bottom of the tri-panel cover arrangement 101, with the first panel 102 pivoted relative to the second panel 104 to be stacked above the second panel 104 in an inverted configuration, and the third panel 106 pivoted relative to the second panel 104 to be stacked above the first panel 102 in an inverted configuration, wherein the one or more second hinges 112 provide sufficient clearance between the second panel 104 and the third panel 106 to position the first panel 102 therebetween.

In the first, closed configuration, where all of the panels 102, 104, 106 are aligned substantially coplanar to each other to cover the truck bed opening, the rail assembly 108 may feature mechanisms that allow the rollers to settle into detents. This alignment shifts the weight of the tonneau cover 100 from rollers to a seal positioned between the tri-panel cover arrangement 101 and the top of the truck bed, thereby compressing the seal to create a moisture-resistant barrier between the bottom of the panels 102, 104, 106 and the truck bed top.

Additionally, in some embodiments, at least one of the panels (e.g., the second panel 104) may include one or more water collection channels configured to encompass the drip edge of an adjoining panel (e.g., at least one of the first panel 102 and/or third panel 106) on three sides, serving to inhibit water intrusion along the hinged edges between panels. Furthermore, these water collection channels can extend laterally towards the sides of the truck, over the rail assembly 108, ensuring that water exiting the channels is directed outside the perimeter of the rail assembly 108, effectively inhibiting water from flowing back into the truck bed along the edges.

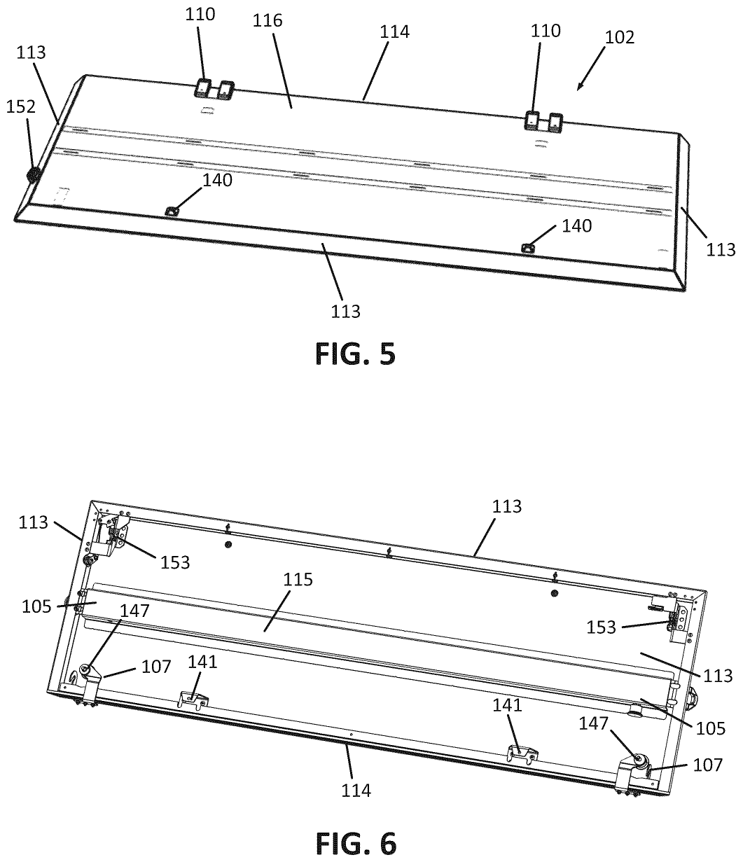

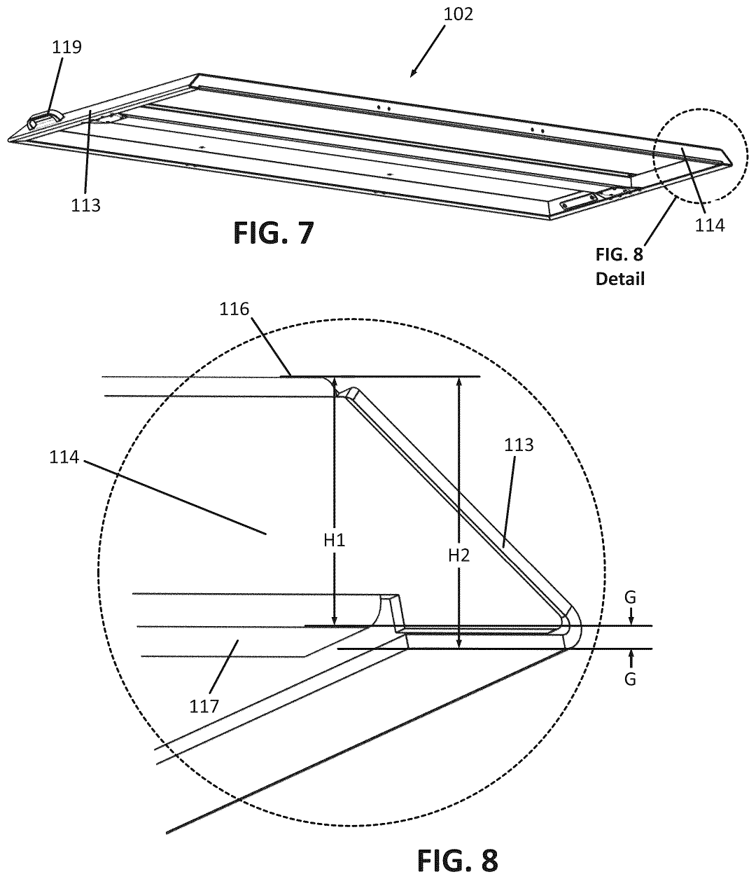

With additional reference to FIGS. 5-10, additional views of a first panel 102 are depicted in accordance with an embodiment of the disclosure. In some embodiments, the first panel 102 can be constructed out of a rigid material (e.g., sheet metal, etc.) which can be bent into a desired final shape representing the first panel 102. For example, in some embodiments, one or more edges of the first panel 102 can be bent to form a chamfered or beveled edge 113

First Panel (e.g., see detail in FIG. 8). As depicted, the first panel 102 includes three beveled edges 113, representing at least portions (e.g., right, left, and rear edges) of an external edge of the tri-panel cover arrangement 101.

Additionally, one or more edges (e.g., a front edge) of the first panel 102 can be configured as a hinge edge 114 extending substantially orthogonal to a top surface 116 of the first panel 102. For improved structural rigidity, in some embodiments, a bottom edge 117 of the hinge edge 114 can be rolled or curled inwardly (e.g., to extend substantially orthogonal to the hinge edge 114). Moreover, a height (H1) of the hinge edge 114 represented as the distance between the top surface 116 and the bottom edge 117 can be less than a height (H2) of the beveled edges 113, thereby enabling one or more water collection channels defined by the second panel 104 to be positioned thereunder. For example, in some embodiments, the difference between H2 and H1 can define a gap distance (G) of between about 0.9 inches and about 0.1 inches, although other gap distances are also contemplated. For example, in one embodiment, the gap distance can be about 0.3 inches.

As further depicted, a portion of first hinges 110 can be operably coupled to the top surface 116 of the first panel 102 adjacent to the hinge edge 114. In other embodiments, the first hinges 110 can be coupled directly to the hinge edge 114 or other surface of the first panel 102. Additionally, one or more pads 140 can be operably coupled to the top surface 116 to provide a cushioned contact with the second panel 104 when the first panel 102 is transitioned to the second, folded configuration. An additional support bumper 141 can be positioned on a bottom surface of the first panel 102, for example to support a portion of the third panel 106 in the second, folded configuration.

The first panel 102 can additionally include a latch or lock arrangement including an actuator mechanism 152 (e.g., keyed lock, handle, etc.) and one or more latch assemblies 153 configured to selectively engage a portion of the rail assembly 108, thereby selectively enabling latching, locking and release of the first panel 102 relative to the rail assembly 108. In the depicted example, the actuator mechanism 152 is in the form of a keyed lock, which upon actuation pivots a latch of the latch assembly 153 between a catch position and a release position, thereby selectively latching, locking and releasing the first panel 102 from the rail assembly 108. In some embodiments, mechanical actuation between latch assemblies 153 positioned on either side of the first panel 102 can be affected through a cable, for example routed through a structural member or within a channel defined by a beveled edge. The latch assemblies 155 can serve to secure the outer edge the first panel to the rail assembly 108 to inhibit vertical movement, such as bouncing, of the first panel 102 relative to the rail assembly 108 when the first panel 102 is in a closed or partially closed configuration.

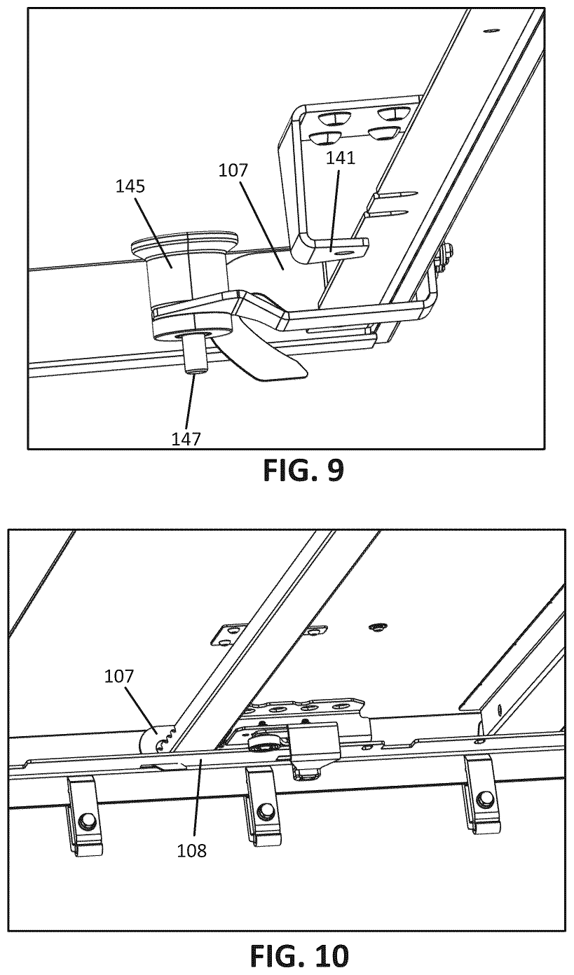

Additionally, as best depicted in FIGS. 9 and 10, in some embodiments, the first panel 102 can include one or more hooks 107 designed to pivot into engaging contact with the rail assembly 108 when the first panel 102 is transitioned to a closed configuration. These hooks 107 can further restrict vertical movement or separation of the tri-panel cover arrangement 101 from the rail assembly 108, enhancing stability and security. Collectively, the hooks 107 can represent components of a mid-panel hold down mechanism, generally configured to inhibit vertical separation (e.g., bouncing) of a mid-section of the tri-panel cover arrangement 101 from the rail assembly 108.

As discussed in further detail below, the first panel 102 can also include an interlock system 145 configured to selectively interlock with the rail assembly 108 to restrict unintentional rolling of the tri-panel cover arrangement in the folded or partially folded configuration. As depicted, the interlock system 145 can include a pin 147, for example, including handle mounted on a cantilevered arm, thereby enabling manipulation of the pin 147 relative to rail assembly 108.

### Third Panel

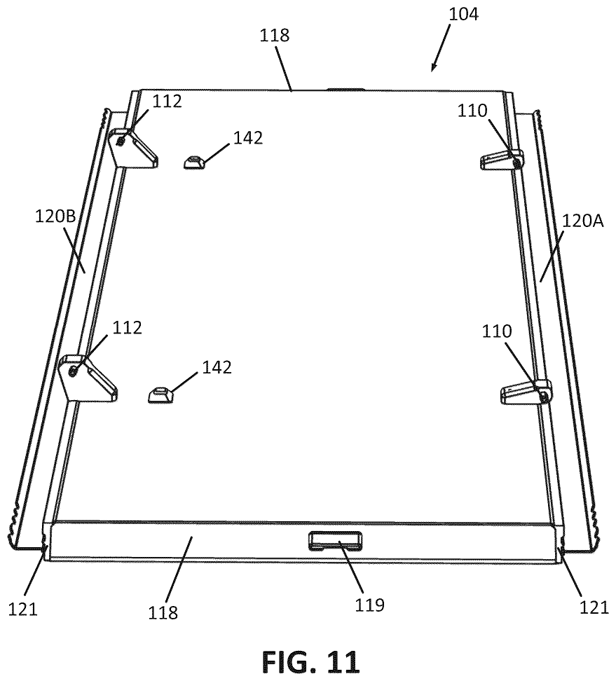

In embodiments, construction of the third panel 106 can be substantially similar to the first panel 102, aside from the distinctive features noted herein. Further as depicted, the first, second and third panels 102, 104, 106 can include one or more structural members 115, for example formed of a three-dimensional sheet-metal structure adhered or otherwise affixed to a major surface of one or more edges of the panels 102, 104, 106. Additionally, as an aid in manipulation of the panels 102, 104, 106, in some embodiments, one or more handles 119 (as depicted in FIG. 11) can be fixedly mounted to one or more of the panels 102, 104, 106. For example, in some embodiments, the structural member 115 can traverse across the panel 102, 104, 106 to add structural rigidity. In some embodiments, the structural member 115 can be at least one of operably coupled to a bottom surface of the panel (e.g., via spot welds, etc.), tied to the beveled edges 113 of the panel (e.g., via a fastener 179), or combination thereof.

### Second Panel

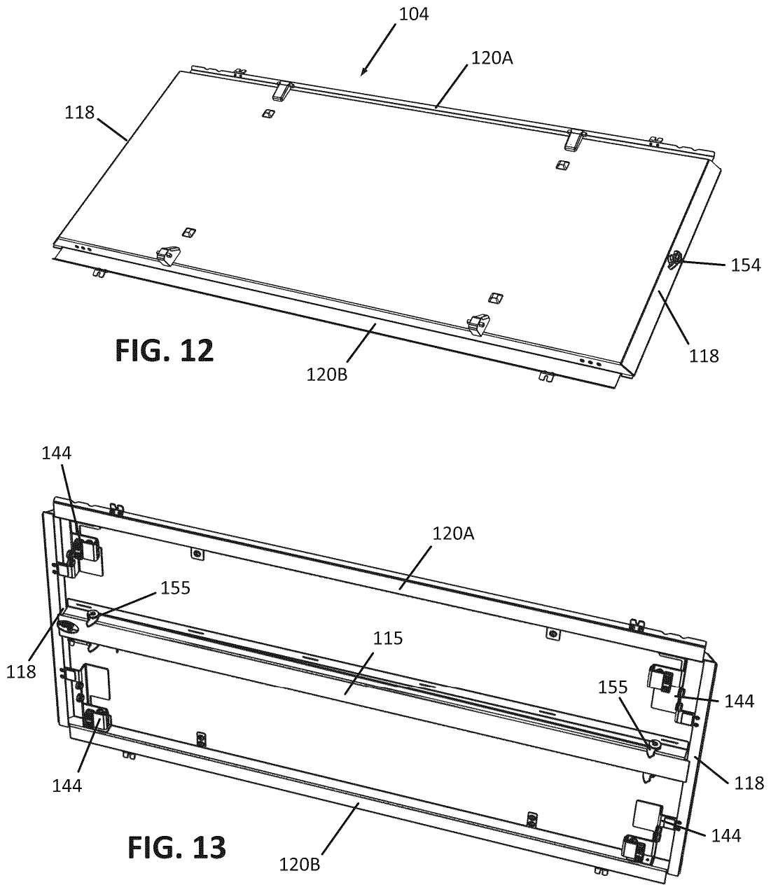

With additional reference to FIGS. 11-13, additional views of a second panel 104 are depicted in accordance with an embodiment of the disclosure. Similar to the first and third panels 102, 106, the second panel 104 can be constructed out of a rigid material (e.g., sheet metal, etc.) which can be bent or otherwise formed into a desired final shape representing the second panel 104. For example, in some embodiments, one or more edges of the second panel 104 can be bent to form a chamfered or beveled edge 118. As depicted, the second panel 104 includes two beveled edges 118, representing portions of the external side (e.g., left and right) edges of the tri-panel cover arrangement 101. Additionally, as depicted, the second panel 104 includes a pair of water collection channels (e.g., positioned along the forward and aft edges), including first water collection channel 120A and a second water collection channel 120B respectively positionable under the hinged edges of the first panel 102 and the third panel 106.

As further depicted, a portion of the first hinges 110 and the second hinges 112 can be operably coupled to the top surface or other surface of the second panel 102. Additionally, one or more pads 142 can be operably coupled to the top surface to provide a cushion contact with the first panel 102, particularly when in the second, folded configuration.

As best depicted in FIGS. 13, the second panel 102 can further include a plurality of roller carriages 144 configured to enable the second panel 102 to roll, slide or otherwise traverse along the rail assembly 108. To secure the second panel 102 in position relative to the rail assembly 108, in some embodiments, the second panel can additionally include an actuator mechanism 154 (e.g., keyed lock, handle, etc.) including one or more interlock mechanisms 155 configured to selectively engage a portion of the rail assembly 108. In some embodiments, the interlock mechanism 155 can be part of a translation prevention mechanism configured to passively secure the tri-panel cover arrangement 101 at one or more predefined positions along the rail assembly 108. In other embodiments, the second panel 102 can include a keyed lock or other type of latch configured to secure the second panel 102 to the rail assembly 108.

### Water Collection

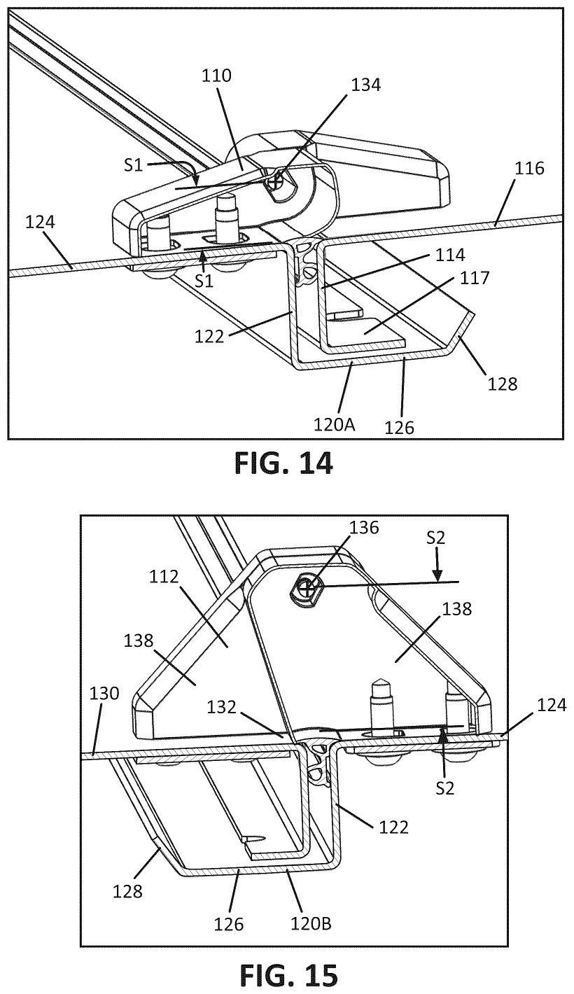

As depicted in FIGS. 14-15, in embodiments, each of the water collection channels 120 can include a hinge edge 122 extending substantially orthogonal to a top surface 124 of the second panel 104. A channel bottom 126 can extend outwardly away from the hinge edge 122 (e.g., at an orthogonal angle) to define a bottom of the water collection channel 120. A sidewall 128 can extend upwardly from the channel bottom 126 opposite the hinge edge 122 (e.g., at an oblique angle). Additionally, a seal member 121 (as depicted in FIG. 11) can be positioned between the hinge edge 122 of the second panel 104 and the hinge edge 114 of the first panel 102 (or equivalent surface of the third panel 106), forming a barrier designed to mitigate the ingress of moisture between these panels.

The hinge edge 122, channel bottom 126, sidewall 128, and the seal member 121 collectively form a comprehensive moisture management system within the tri-panel cover arrangement 101. The seal member 121 acts as the first line of defense against moisture ingress. However, in instances where moisture manages to traverse past the seal member 121, it is directed into the water collection channels 120.

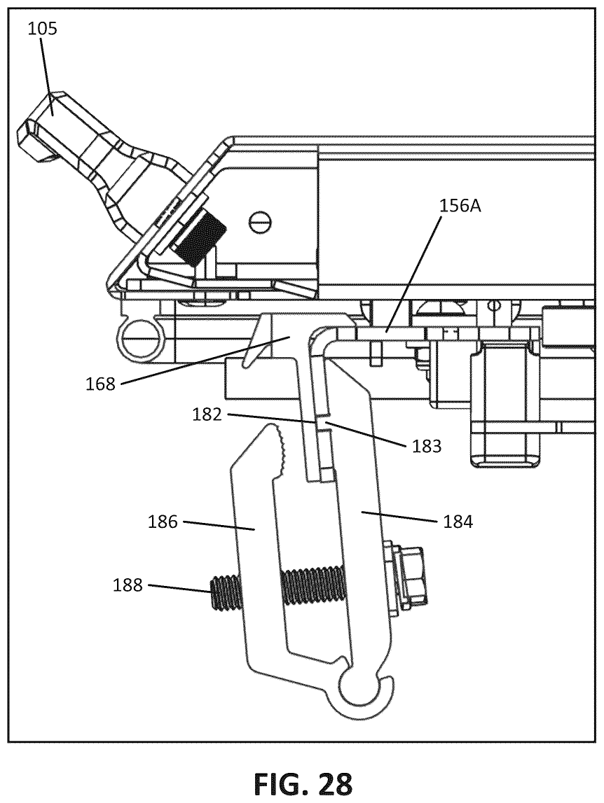

The hinge edge 122, channel bottom 126 and sidewall 128 can collectively form three sides of a water collection channel 120, which can be configured to be positioned beneath the bottom edge 117 of the hinge edge 114 of the first panel 102 (and equivalent surface of the third panel 106), thereby providing a path for the removal of moisture introduced along the hinge edges 114, 122 when the tri-panel cover arrangement 101 is in the first, closed configuration. As depicted, in some embodiments, the water collection channel 120 is configured to surround the bottom edge 117 of the first panel 102 (and equivalent surface of the third panel 106) on three sides. This configuration provides a pathway for removing moisture that accumulates along the hinge edges 114, 122 when the tri-panel cover arrangement 101 is in its first, closed configuration. Furthermore, the water collection channels 120 extend laterally towards the sides of the truck, over the rail assembly 108 and adjacent to the seal member 168 (as depicted in FIG. 28), which ensures that water exiting the water collection channels 120 is directed outside the perimeter of the rail assembly 108, inhibiting water from flowing back into the truck bed along the edges.

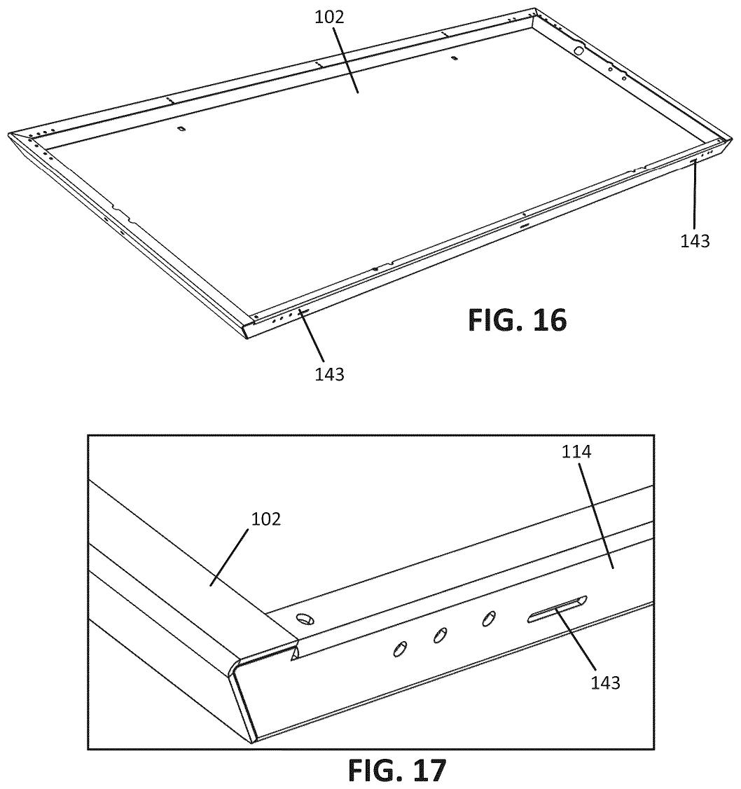

Additionally, in some embodiments, the tonneau cover 100 can be configured to manage water in its folded or partially folded configurations. Specifically, water collected on the inverted first panel 102 or the inverted third panel 106 can be directed towards a water collection channel 120. As depicted in FIG. FIGS. 16-17, either the first panel 102 or the third panel 106 can define one or more drain apertures 143. The one or more drain apertures 143 can be configured to enable water accumulated on either of these inverted panels, when positioned atop the second panel 104, to drain into the water collection channel 120A-B defined by the second panel 104 to ensure that water management is maintained even when the tonneau cover is not fully deployed.

### Hinges

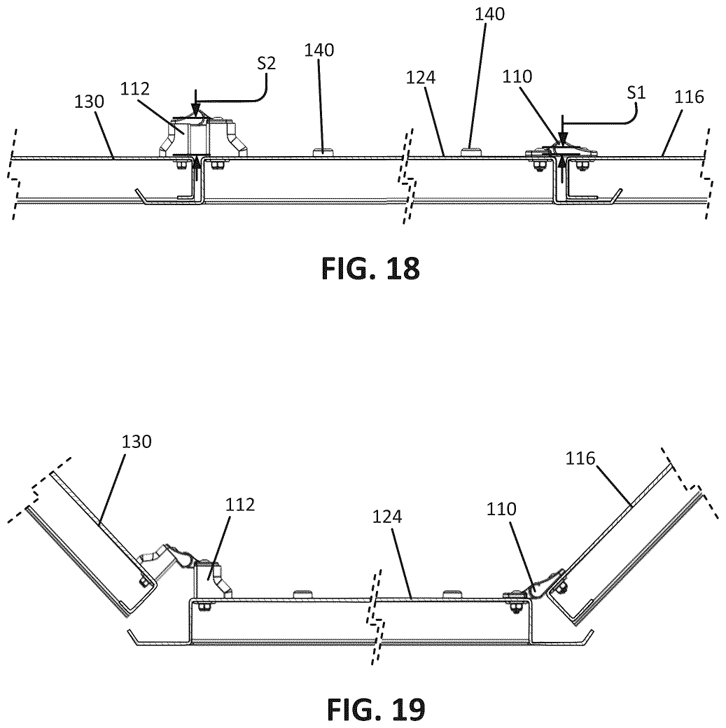

With additional reference to FIGS. 18-19, the first hinges 110 can be surface mount hinges operably coupled to the respective top surfaces 116, 124 of the first and second panels 102, 104, thereby enabling the first panel 102 to pivot relative to the second panel 104 about the hinge edges 114, 122. Similarly, the second hinges 112 can be surface mount hinges operably coupled to the respective top surfaces 124, 130 of the second and third panels 104, 106, thereby enabling the third panel 106 to pivot relative to the second panel 104 about hinge edges 122, 132. In embodiments, the first hinges 110 can provide a pivot point 134 positioned at a first distance (S1) above the top surface 124 of the second panel 104, and the second hinges 112 can provide a pivot point 136 positioned at a second distance (S2) above the top surface 124 of the second panel 104, wherein the second distance S2 is greater than the first distance S1 by at least half of a thickness of the first panel 102 (e.g., wherein a thickness of the first panel is substantially equal to a height (H2) of the beveled edges 113), thereby enabling the first panel 102 to be stacked between the second panel 104 and the third panel 106. For example, in some embodiments, the second hinges 112 can include a spacer 138 having a dimension approximately equal to half of the thickness (e.g., 0.5×H2) of the first panel 102.

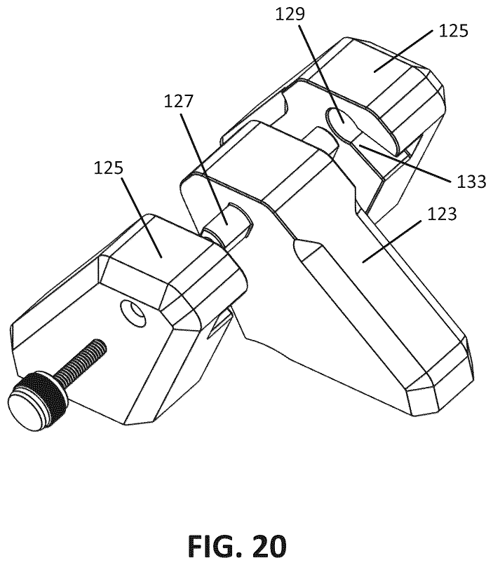

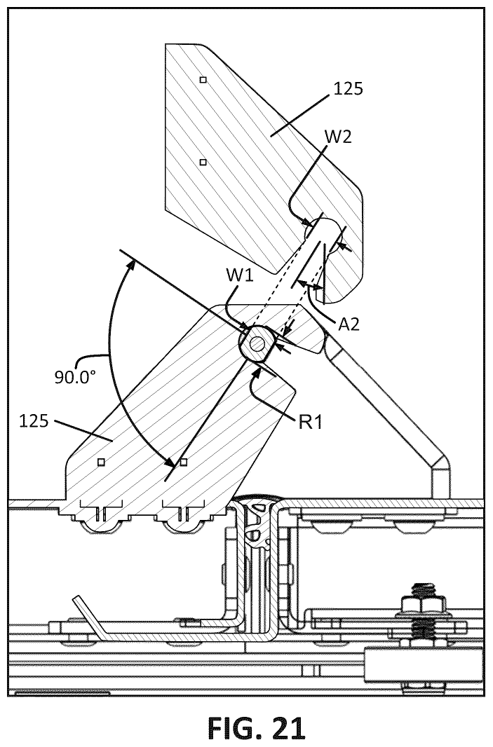

In some embodiments, the hinges 110, 112 can be configured to enable the panels 102, 104, 106 to be detached, facilitating the disconnection and selective removal of one or more panels from the tri-panel cover assembly without the use of tools (e.g., toolless removal of the tri-panel cover assembly). This feature is highlighted in additional details with FIGS. 20-21, where each hinge 112 can include a primary wing 123 attached to the top surface of the second panel 104, and one or more secondary wings 125 that can be affixed to the top surface of either the first or third panels 102, 106. The primary wing 123 can include a locking element or pin 127 that slots into a knuckle 129 located on the secondary wings 125, allowing for rotational movement and easy disassembly. Other embodiments are provided with hinges that require a key, or other tool to enable detachment of the panels 102, 104, 106. For example, in some embodiments, pin 127 can be replaced by threaded fastener.

To enable separation, the pin 127 can define a pair of opposed flat surfaces 131, modifying and otherwise round cross-section of the pin 127 into a narrower profile that can pass through a channel 133 in the knuckle 129. While the original diameter of the pin 127 is defined by radius R1, the flattened sides reduce a width of the pin 127 to W1, which is less than R1, to ensure that the pin 127 can pass through the channel 133 in the knuckle 129 only when aligned properly, with the channel's width W2 being slightly larger than W1 but smaller than R1. In some embodiments, alignment necessary for disengagement can occur when one of the panels, either the first panel 102 or the third panel 106, is rotated about 90° to a nearly vertical position relative to the second panel 104. As further depicted in FIGS. 16-17, in some embodiments, the channel 133 can be set at an angle Al to the vertical, requiring a combined upward and outward motion to navigate the pin 127 through the channel 133 for panel removal.

Alternatively, in some embodiments, a dual hinge arrangement akin to that used frameless cabinet door hinges can be employed to achieve similar functionality as described previously. This hinge arrangement can include two pivot points connected by a central section, thereby facilitating the desired positioning of the first panel 102 and third panel 106 relative to the second panel 104.

### Operational Configurations

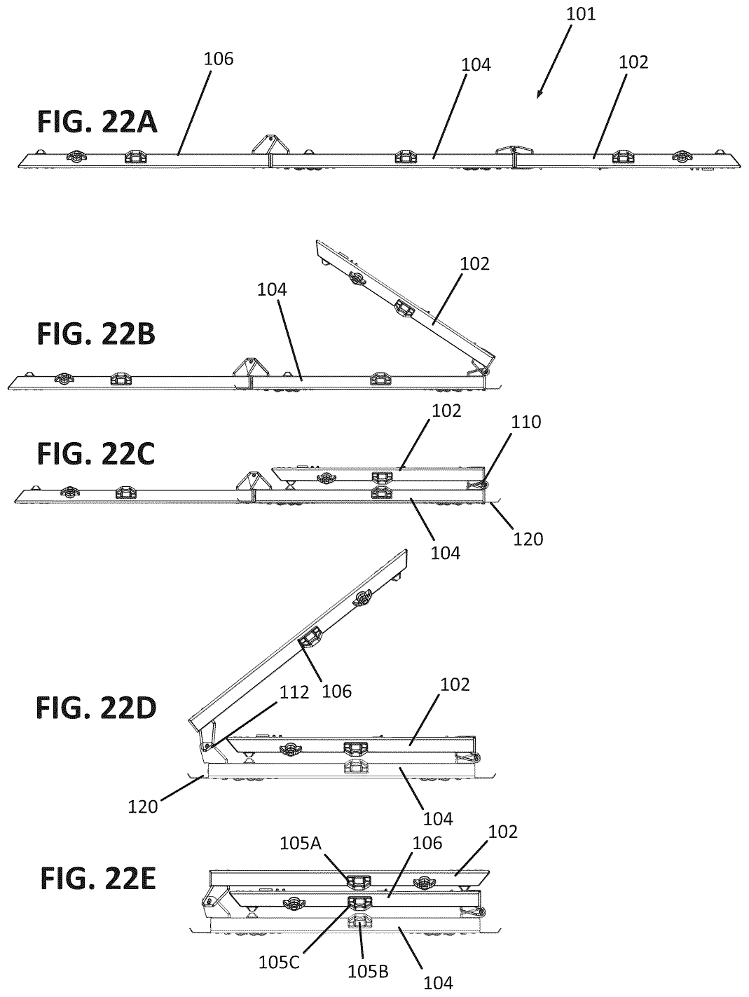

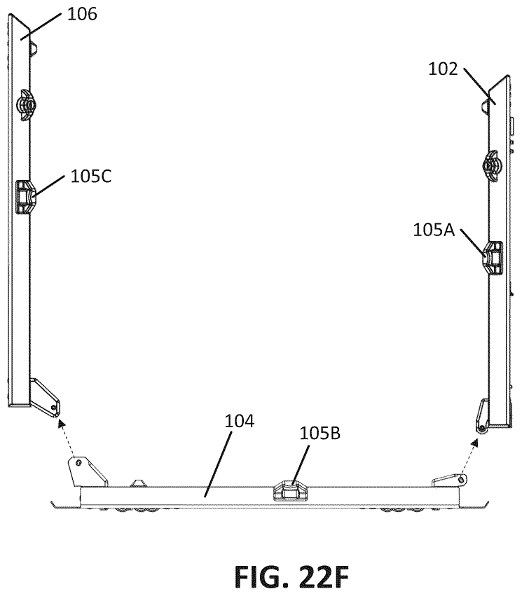

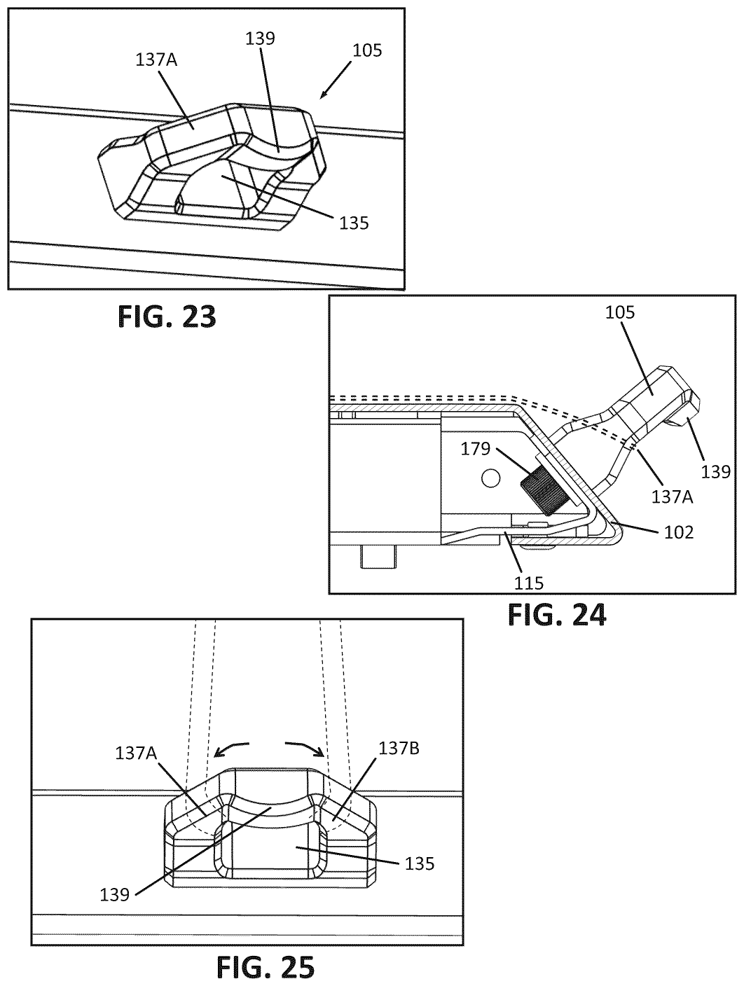

As further depicted in FIGS. 22A-F, in operation the tonneau cover 100 can transition from a first, closed configuration (as depicted in FIG. 22A) to a second, folded configuration (as depicted in FIG. 22E). For example, as depicted in FIG. 22B, the first panel 102 can be pivoted relative to the second panel 104 about the first hinges 110, thereby flipping the first panel 102 inverted so that the top surface 116 of the first panel 102 faces the top surface 124 of the second panel 104 (as depicted in FIG. 22C). In some embodiments, one or more bumpers or pads 140, 142 may be positioned between the panels 102, 104 to inhibit scratching.

Thereafter, the third panel 106 can be pivoted relative to the second panel 104 about the second hinges 112 (as depicted in FIG. 22D), thereby flipping the third panel 106 inverted so that the top surface 130 of the third panel 106 faces the top surface 124 of the second panel 104 (as depicted in FIG. 22E). Accordingly, the first panel 102 can come to rest on the top of the second panel 104, and the third panel 106 can come to rest on the top of the first panel 102. In some embodiments, one or more support bumpers 141 or pads 140 may be positioned between the panels 102, 106 to inhibit scratching.

The tri-panel cover arrangement 101 enables a variety of operational configurations. For example, in some implementations, it may be desirable to uncover approximately one third of the truck bed (e.g., to obtain limited access to the contents of the truck bed, to enable contents of the truck bed to extend above the top perimeter of the truck bed, etc.). In such an implementation, either of the first panel 102 or the third panel 106 can be folded relative to the second panel 104. Alternatively, the first panel 102 or the third panel 106 can be removed from the second panel 104 (as depicted in FIG. 22F).

In other implementations, it may be desirable to uncover approximately two thirds of the truck bed. Further, it may be desirable to shift the tri-panel cover arrangement 101 fore or aft relative to the truck bed. In such an implementation, both the first panel 102 and the third panel 106 can be folded relative to the second panel 104, so as to position the tri-panel cover arrangement 101 in the first, folded configuration. Thereafter, the tri-panel cover arrangement 101 can be shifted either forward or aft relative to the truck bed via the rail assembly 108, thereby permitting improved access to the contents of the truck bed by selectively exposing a portion of the truck bed that would be otherwise covered by the second panel 104.

Additionally, at least one of a forward or aft edge of the second panel 104 (e.g., adjacent to either of the first or second water collection channels 120A, 120B) can be selectively decoupled from the rail assembly 108, thereby enabling the folded tri-panel cover arrangement 101 to be pivoted relative to the rail assembly 108, further uncovering a greater portion of the truck bed. Once pivoted, the folded tri-panel cover arrangement 101 can, in some embodiments, be detached from the rail assembly 108 for removal from the truck bed, while the rail assembly 108 remains securely mounted within the truck bed.

### Tie Downs

With reference to FIGS. 25-27, a tiedown 105 having a curved shape that facilitates the management of tiedown straps is depicted. In such an embodiment, the curvature of the tiedown 105 can serve to guide a tiedown strap into one of two stable positions, thereby preserving the strap's tautness.

As depicted, in some embodiments, the tiedown 105 includes an aperture 135, through which the tiedown strap can be threaded, enabling a secure and straightforward attachment. Each of the tiedowns 105 can further include a hump 139 flanked by a pair of saddle surfaces 137A and 137B, positioned on either side of the hump 139. These saddle surfaces 137A and 137B can be shaped to represent the minimum distance a tiedown strap needs to span across each panel 102, 104, 106, which enables the tiedown strap, when stretched from side to side across a panel and nestled into either saddle surface 137A and 137B, to maintain a secure and snug fit across the panel, minimizing slack and ensuring the tiedown strap remains taunt.

Moreover, in some embodiments, the utility of the tiedowns 105 can further be enhanced by their operational coupling to a structural member 115, as depicted in earlier FIGS. 2-4, which not only bolsters the overall structural integrity of the tonneau cover 100 but also serves to more evenly distribute tension from the tiedown straps. For instance, the structural member 115 can be at least one of operably coupled to a bottom surface of the panel, for example, via spot welds or other suitable attachment means, or tied to the beveled edges 113 of the panel, for example, via a fastener 179, or a combination thereof, having the effect of increasing the structural rigidity of the tonneau cover 100. Furthermore, in some embodiments, each of the structural member 115 and the panel can define an aperture through which fastener 179 can pass for receipt into a threaded aperture defined by the tiedown 105. Accordingly, in some embodiments, the fastener 179 provides a direct mechanical linkage between the structural member 115 and the tiedown 105, further enhancing the integrated strength and functionality of the tonneau cover system.

Furthermore, in some embodiments, the folded configuration allows for alignment of one or more tiedowns 105 mounted to the respective sides of the first, second, and third panels 102, 104, 106. Specifically, apertures defined by tiedowns 105A, 105B, 105C can be positioned atop one another (e.g., vertically aligned, staggered, etc.) to facilitate the passage of a strap therethrough, aiding in securing the panels in their folded state. This feature adds an additional layer of convenience and security to the tri-panel cover arrangement, particularly to folded panel retention in either the fully or partially folded configuration.

In some embodiments, a standalone tiedown similar to the one disclosed can be adapted for attachment to an existing tonneau cover, such as in an aftermarket modification. The installation of the standalone tiedown can involve securing it to the tonneau cover using a pair of fasteners 179, which may pass through a pair of apertures defined in the tonneau cover.

### Rail and Latch Assemblies

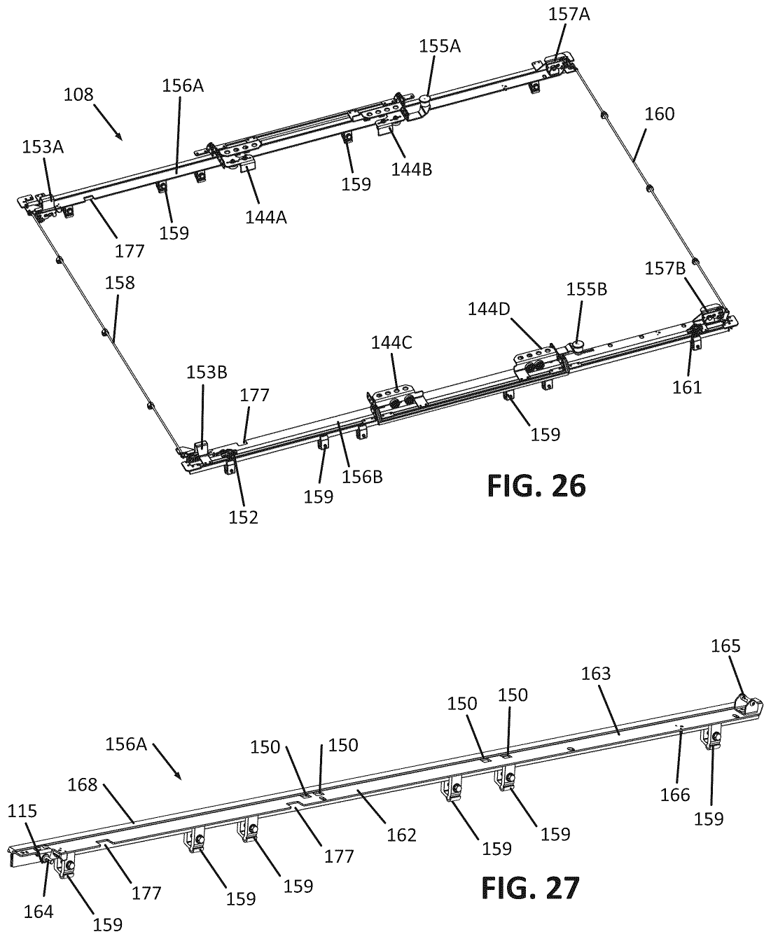

With additional reference to FIG. 26, a rail assembly 108 is depicted in accordance with an embodiment of the disclosure. As depicted, the rail assembly 108 can be configured to engage with the latch assemblies 153A, 153B of the first panel 102, the roller carriages 144A, 144B, 144C, 144D of the second panel 104, the interlock mechanisms 155A, 155B of the second panel 104, and the latch assemblies 157A, 157B of the third panel 106. As depicted, cables 158 and 160 can operably couple the respective latch assemblies 153A, 153B of the first panel 102, and latch assemblies 157A, 157B of the third panel 106, thereby enabling simultaneous operation of both driver and passenger side latch assemblies with a single actuator (e.g., actuator mechanisms 152, 161).

The latch assemblies 153A, 153B on the first panel 102 and 157A, 157B on the third panel 106 can serve to secure the outer edges of these panels to the rail assembly 108 to inhibit vertical movement, such as bouncing, of the first and third panels relative to the rail assembly 108 when they are in a closed or partially closed configuration. Additionally, in some embodiments, both the first panel 102 and the third panel 106 can be equipped with one or more hooks 107 (as best depicted in FIGS. 9-10), configured be pivoted into engaging contact with the rail assembly 108 when the panels are transitioned to a closed configuration. In embodiments, the one or more hooks 107 can further restrict vertical movement or separation of the tri-panel cover arrangement 101 from the rail assembly 108, enhancing the stability and integrity of the entire cover system during use.

In embodiments, the rail assembly 108 can include first and second rails 156A, 156B mountable on the respective left and right sides of the truck bed. For example, in some embodiments, the first and second rails 156A, 156B can be secured to the truck bed by one or more clamps 159, such as that disclosed in U.S. Patent Application No. 63/526,006, filed Jul. 11, 2023, the contents of which are incorporated by reference herein.

For example, as depicted in FIG. 28, in some embodiments, the each clamp 159 can include a first jaw member 184, a second jaw member 186, and a threaded member 188. In embodiments, the first jaw member 184 can define a first contact surface configured to contact a portion of the pickup truck box. The second jaw member 186 can be pivotably coupled to the first jaw member 184 and can define a second contact surface configured to contact a portion of the rail assembly 108. The threaded member 188 can be operably coupled to the first jaw member 184 and the second jaw member 186, and can be configured to pivot the second jaw member 186 relative to the first jaw member 184 to adjust the distance between the first contact surface and the second contact surface to selectively exert a gripping pressure on a portion (e.g., a flange, etc.) of the pickup truck box.

As further depicted, in some embodiments, each of the first and second rails 156A, 156B can define a slot 182, and each of the clamps 159 can define a tab 183, configured to be received within the slot 182. This arrangement can be configured to inhibit rotation of the clamp 159 relative to the rails 156A, 156B, particularly when torque is applied to secure the clamp 159 in place relative to the truck bed. The slots 182 can be positioned along the rails at predetermined securement locations (e.g., specific to the make and model of truck) along the length of the first and second rails 156A, 156B to facilitate the positioning of the clamp 159 relative to the truck bed. Further configurations are also contemplated, including swapping the positions of the tab and slot, or employing alternative mating mechanisms such as a tongue and groove assembly in place of the tab and slot, to allow for different assembly requirements or design preferences.

### Rails

A perspective view of the first rail 156A is depicted in FIG. 27. As depicted, each rail 156 can include a substantially rigid rail member 162 defining a roller surface 163 upon which one or more roller wheels carried by the roller carriages can roll. For example, in one embodiment, the substantially rigid rail member 162 can generally define an L-shaped cross-section, defining a roller surface and a substantially orthogonal attachment surface coupleable to a portion of the truck bed.

As further depicted in FIG. 27, each of the substantially rigid rail members 162 can define a first striker element or post 164 and a second striker element or post 165. In some embodiments, the first post 164 can be positioned below the roller surface 163 and the second post 165 can be positioned above the roller surface 163. Further, in some embodiments, each of the substantially rigid rail members 162 can include one or more bumpers 166 to restrict or inhibit sliding of the tri-panel cover arrangement 101 relative to the rail assembly 108, particularly in the second, folded position.

Environmental Seal/Interaction with Detents

In embodiments, each of the first and second rails 156A, 156B can include a seal member 168. In embodiments, the seal member 168 can create a fluid barrier between the substantially rigid rail member 162 and the truck bed, as well as between the tri-panel cover arrangement 101 and a top of the truck bed or rail assembly 108.

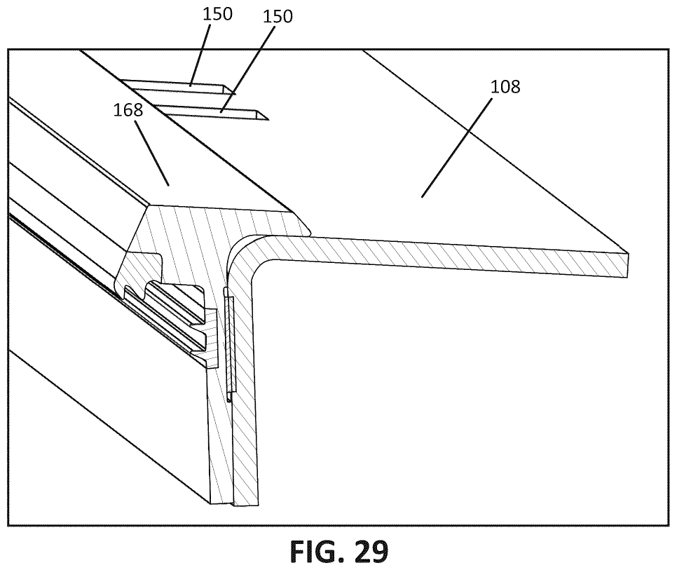

With additional reference to FIG. 29, the rail assembly 108 is designed to mate with a rail seal 168 using adhesive 169. To facilitate a secure and lasting bond, in some embodiments, the rail assembly 108 can define an adhesive channel 173, shaped and sized to receive the adhesive 169, ensuring that when applied, a flush and uninterrupted contact between the higher durometer core 175 of the rail seal 168 and the rail assembly 108 can be established.

As further depicted, in some embodiments, the rail seal 168 can include a higher durometer core 175, providing a robust backbone to which one or more lower durometer components 171A and 171B are affixed for improved sealing capabilities with the contours of the truck bed. In embodiments, the first lower durometer component 171A can be positioned to form a tight seal against the vertical surfaces of the truck bed or body. Conversely, the second lower durometer component 171B can be positioned to form a tight seal against the horizontal surfaces of the truck bed or body. The orthogonal arrangement of these two components 171A, 171B addresses both vertical and horizontal surfaces with precision.

In the first, closed configuration, the first, second, and third panels 102, 104, 106 of the tri-panel cover arrangement can rest on the seal member 168 such that a drip edge of each panel extends beyond the seal member 168. This extension encourages water drainage over and outside of the truck bed, further enhancing the protective functionality of the cover.

As an aid in ensuring a desired seal, in some embodiments, each of the substantially rigid rail members 162 can define one or more detents 150 shaped and sized to receive respective portions of roller wheels carried by the roller carriages 144, thereby enabling the tri-panel cover arrangement 101 to drop down into a weight bearing compressive contact with the seal member 168, thereby compressing the seal member 168 and establishing a moisture resistance seal.

For example, as depicted, the second panel 104 can be equipped with four roller carriages 144A-D. A first set of roller carriages 144A-B can be positioned on one lateral side of the second panel 104, while a second set of roller carriages 144C-D can be positioned on the opposite lateral side. Each roller carriage 144 can include a pair of roller wheels 146. In some embodiments, a spacing between the roller wheels 146 of a particular roller carriage 144A-D can be specifically tailored or unique to match the spacing between detents 150 defined by the rail assembly 108, thereby enabling only the roller carriage 144 with roller wheels 146 aligned to the spacing of the detents 150 to drop into the detents 150 to enable the tri-panel cover arrangement 101 to engage in a weight-bearing compressive contact with the seal member 168. This configuration advantageously permits other roller carriages 144 (e.g., those roller carriages 144 without the spacing matching the detents 150) to continue rolling along the rail assembly without engaging into the detents 150, thus maintaining smooth operation while selectively engaging the sealing mechanism where necessary.

In other embodiments, the roller carriages 144 may feature retractable roller wheels, analogous to an aircraft landing gear system. These roller wheels can be configured to transition between an extended configuration, where the roller wheels contact the rail assembly 108 and allow the roller carriage 144 to roll along the rail, and a retracted configuration, where the wheels are withdrawn, enabling a transfer of the cover's weight onto the seal member 168.

### Latch Assemblies

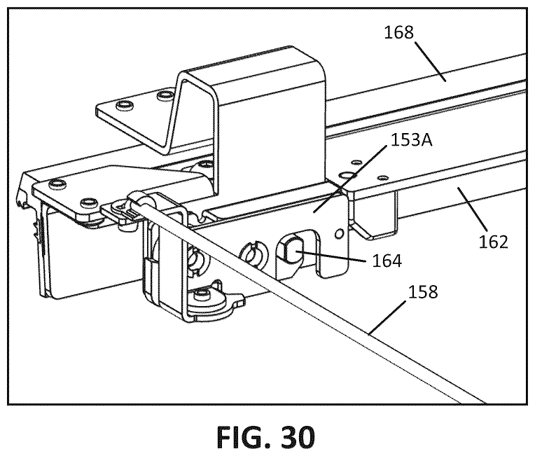

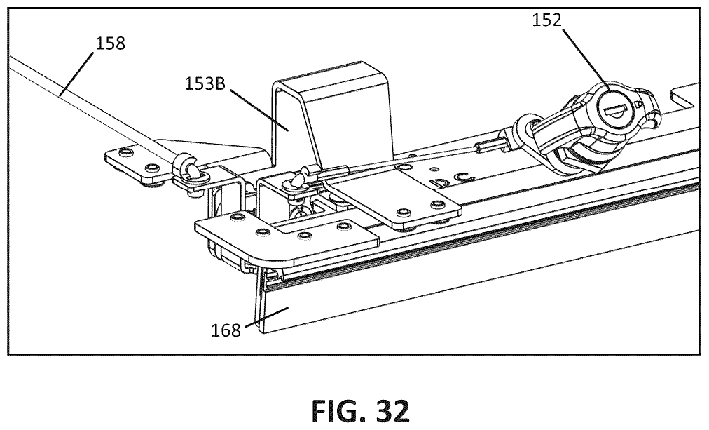

With additional reference to FIGS. 30-32, views of an interaction between the latch assemblies 153A, 153B of the first panel 102 and the rail assembly 108 are depicted in accordance with an embodiment of the disclosure. The actuator mechanism 152 and latch assemblies 153A, 153B can be fixedly coupled to the first panel 102. As depicted, the actuator mechanism 152 can be configured for rotational actuation, which in some embodiments can be locked and unlocked (e.g., via a key). A cable (e.g., cable 158) or other linkage can couple the actuator mechanism 152 to the latch assemblies 153A, 153B, thereby enabling simultaneous actuation of a latch mechanism within each of the latch assemblies 153A, 153B between a catch position to couple to the first post 164 defined by the rail assembly 108, and a release position to decouple from the first post 164.

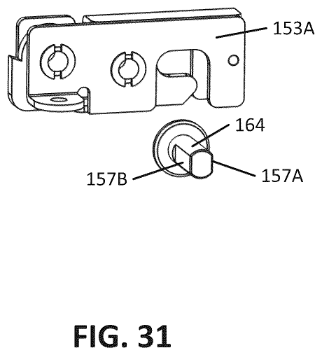

In some embodiments, the first post 164 can have a substantially cylindrical cross-section. Alternatively, the first post 164 can have an otherwise cylindrical cross-section featuring a pair of opposed flat surfaces 167A, 176B (as depicted in FIG. 31), resembling chords on opposing sides of the cylindrical cross-section. The latch assemblies 153A, 153B can operate through a catch-and-release mechanism engaging with a first post 164. The flat surfaces 167A, 176B can be designed to facilitate the operation of the latch assemblies 153A, 153B across a broader range of tolerances, such as to accommodate variations in the truck bed's shape and size.

Accordingly, an aft most edge of the first panel 102 can be held in engaging contact with the rail assembly 108, particularly when the tri-panel cover arrangement 101 is in the first, closed configuration. Moreover, the actuator mechanism 152 and latch assemblies 153A, 153B can aid in securing a bottom edge of the first panel 102 in close contact with the seal member 168, thereby creating a moisture resistant barrier between the first panel 102 and the top of the truck bed or rail assembly 108.

### Interlock System

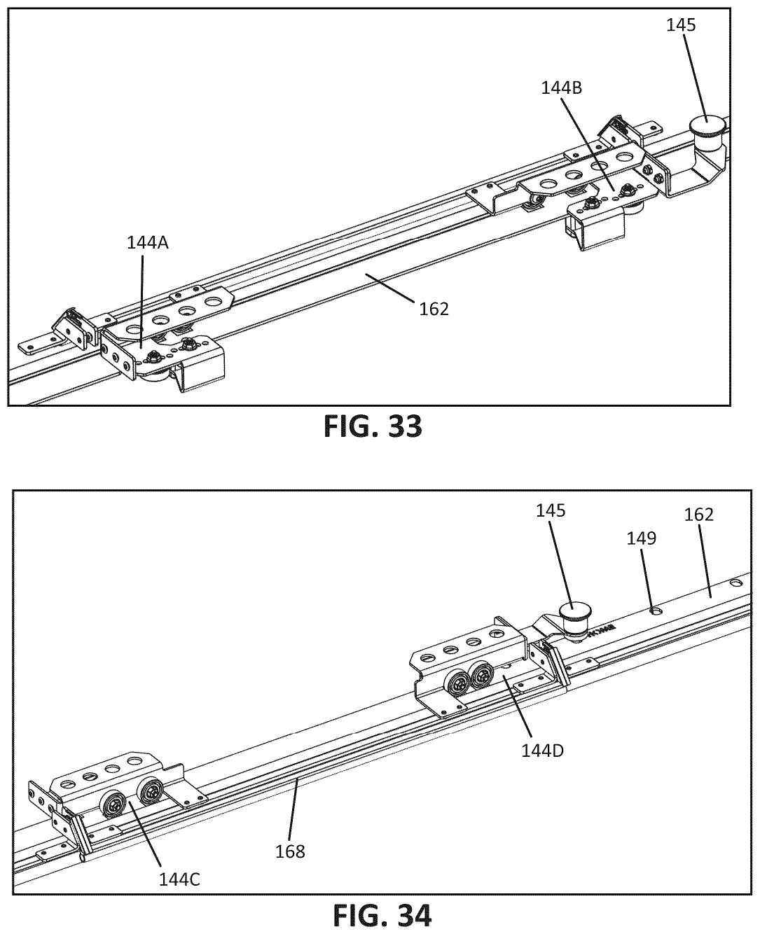

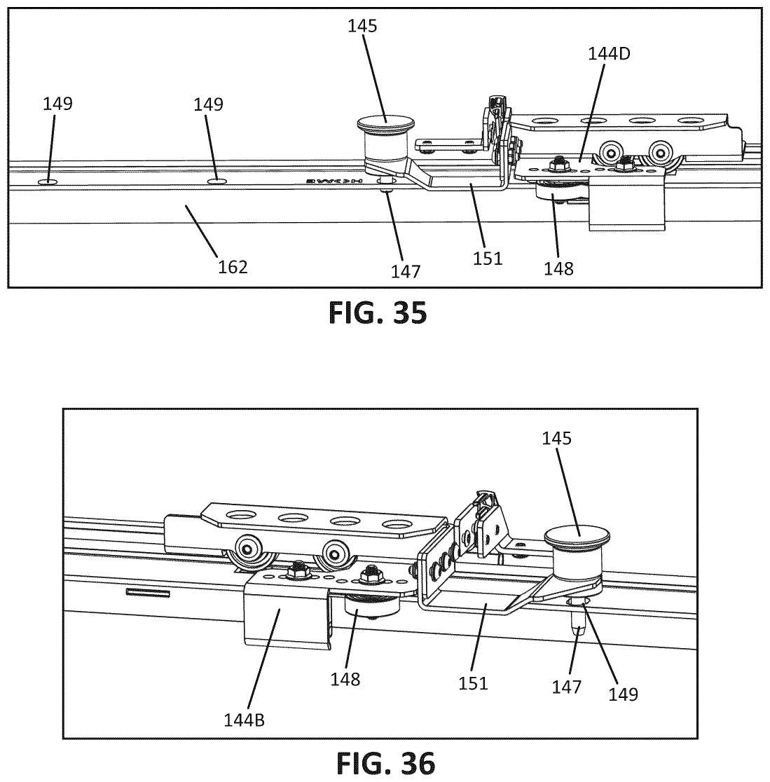

With additional reference to FIGS. 33-36, the interaction between roller carriages 144A, 144B, 144C, and 144D with the rail assembly 108 is illustrated in accordance with an embodiment of the disclosure. The roller carriages 144A, 144B, 144C, and 144D, which can be attached to the second panel 104, can facilitate a rolling or sliding movement of the tri-panel cover arrangement 101 along the rail assembly 108. In certain embodiments, at least one roller carriage can incorporate an interlock system 145, alternatively referred to as a translation prevention mechanism, configured to passively secure tri-panel cover arrangement 101 at one or more predefined positions along the rail assembly 108.

In some embodiments, the interlock system 145 can function as a failsafe mechanism to prevent inadvertent sliding of the tri-panel cover arrangement 101 along the rail assembly 108. This is particularly useful when either the first panel 102 or the third panel 106 is transitioned to a closed position, and the vehicle is parked on an incline, where gravity could otherwise cause the tri-panel cover arrangement 101 to slide. The interlock system 145 includes a pin 147, which is spring-biased and configured to engage automatically with one of several apertures 149 defined within the rail assembly 108 at predefined positions. This engagement acts as a passive mechanism to secure the cover arrangement in place, mitigating unintentional movement. Additionally, the pin 147 is mounted on a cantilevered arm 151, which enhances the case of its engagement and disengagement.

Other embodiments are also contemplated. For example, in some embodiments, the interlock system 145 can include a translation prevention mechanism or another type of braking element that requires user interaction to enable movement of the tonneau cover 100. For instance, one side of the cover, such as the driver's side, may utilize a passive interlock system 145 that engages automatically, while the opposite side, possibly the passenger side, could feature a manual version of the interlock system 145. This manual system allows for user-initiated engagement or release, such as releasing a brake, providing additional security and control over the movement of the cover.

### Roller Assemblies

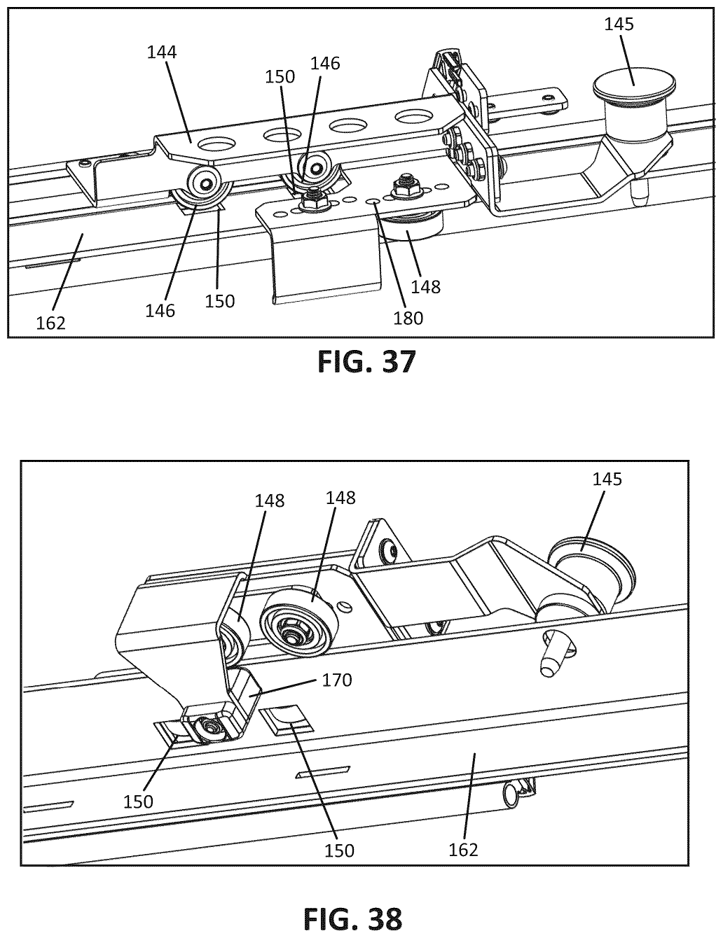

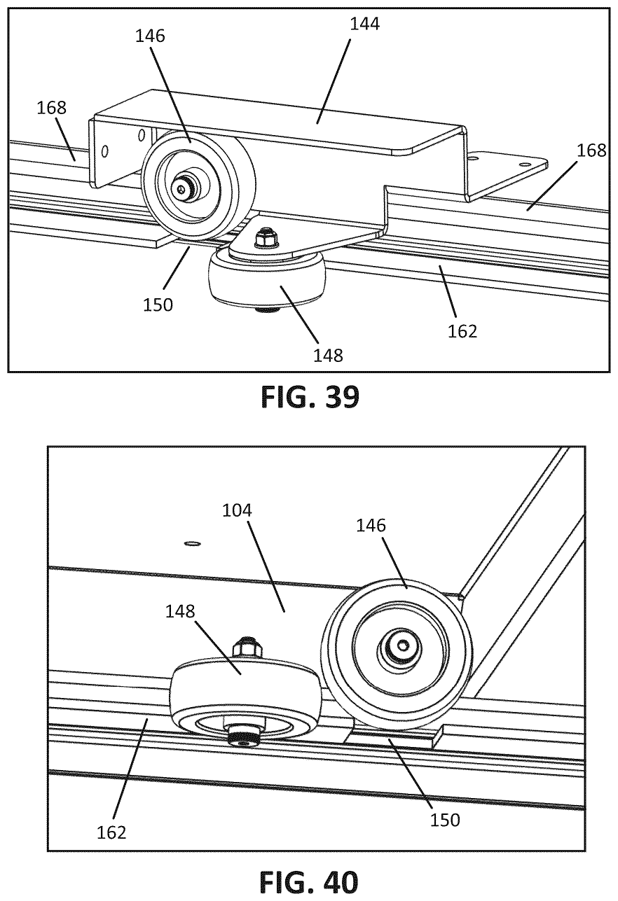

With additional reference to FIGS. 37-40, close-up views of an interaction between a roller carriage 144 and the rail assembly 108 are depicted in accordance with embodiments of the disclosure. As depicted, each of the roller carriages 144 can carry one or more first roller wheels 146, and one or more second roller wheels 148 positioned substantially orthogonal to the first roller wheels 146, such that the first roller wheels 146 generally serve to carry the weight of the tri-panel cover arrangement 101 when sliding the tri-panel cover arrangement 101 relative to the rail assembly 108, and the second roller wheels 148 generally serves to maintain alignment of the tri-panel cover arrangement 101 relative to the rail assembly 108.

Additionally, in some embodiments, the second roller wheels 148 are adjustable to enable lateral positioning of the tri-panel cover arrangement 101 relative to the truck bed. For example, in some embodiments, the roller carriage 144 can define a plurality of apertures 180, enabling for lateral adjustment of the second roller wheels 148. Further, in some embodiments, each of the roller carriages 144 can further define a bumper 170 configured to ride along a bottom surface of the rigid rail member 162.

To encourage sealing contact between the beveled edges of the panels 102, 104, 106, in some embodiments, the rail assembly 108 can define one or more detents 150 into which the first roller wheels 146 can be selectively positioned (e.g., in the first, covered configuration, etc.), thereby effectively transferring the weight of the tri-panel cover arrangement 101 from the first roller wheels 146 to the beveled edges of the panels 102, 104, 106. In embodiments that include a pair of spaced apart roller wheels 146 (e.g., as depicted in FIGS. 37-38), alignment of the first roller wheels 146 with the corresponding detents 150 serves to secure the second panel 104 in a specific position along the rail assembly 108, and also causes a slight downward movement of the second panel 104 into a detent position, which has the effect of shifting the weight of the cover from the roller wheels 146 onto the beveled edges of the panels, ensuring a tight seal. In some embodiments, the seal member 168 can be positioned (e.g., and compressed) between the beveled edges of the panels 102, 104, 106 and the top edge of the truck bed to reduce intrusion of water and debris.

In some embodiments, the second panel 104 can include four roller carriages 144A-D, with two sets positioned on opposite lateral sides of the panel. Each roller carriage 144 can include a pair of roller wheels 146, with a spacing between roller wheels 146 tailored to match the detents 150 defined by the rail assembly 108, to ensure that only roller carriages 144 with correctly spaced roller wheels 146 engage in weight-bearing contact with the seal member 168, allowing others to roll smoothly without engaging the detents 150, thus maintaining operational efficiency while selectively activating the sealing mechanism.

### More on Latch Assemblies

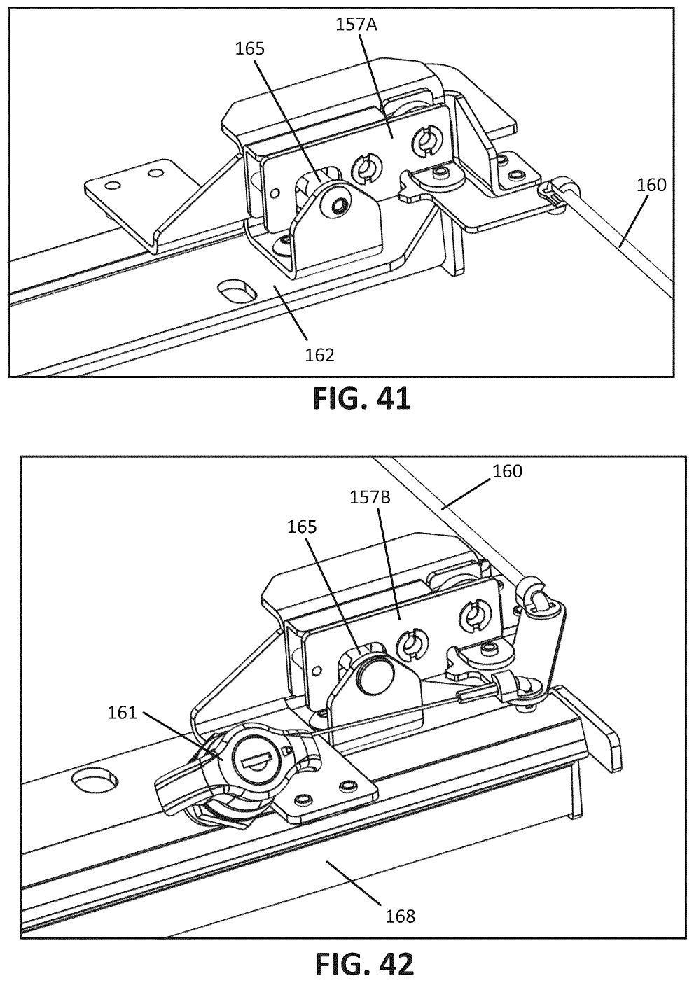

With additional reference to FIGS. 41-43, views of an interaction between the latch assemblies 157A, 157B of the third panel 106 and the rail assembly 108 are depicted in accordance with an embodiment of the disclosure. The actuator mechanism 161 and latch assemblies 157A, 157B can be fixedly coupled to the third panel 106. Similar to the first panel 102, the actuator mechanism 161 of the third panel 106 can be configured for rotational actuation, which in some embodiments can be locked and unlocked (e.g., via a key). A cable (e.g., cable 160) or other linkage can couple the actuator mechanism 161 to the latch assemblies 157A, 157B, thereby enabling actuation of a latch within each of the latch assemblies 157A, 157B between a catch position to couple to the second post 165 defined by the rail assembly 108, and a release position to decouple from the first post 164.

Accordingly, the front portion of the third panel 106 can be held in engaging contact with the rail assembly 108, particularly when the tri-panel cover arrangement 101 is in the first, closed configuration. Moreover, the actuator mechanism 161 and latch assemblies 157A, 157B can be configured to aid in urging a bottom edge of the third panel 106 into close contact with the seal member 168, thereby creating a moisture resistant barrier between the third panel 106 and the top of the truck bed or rail assembly 108.

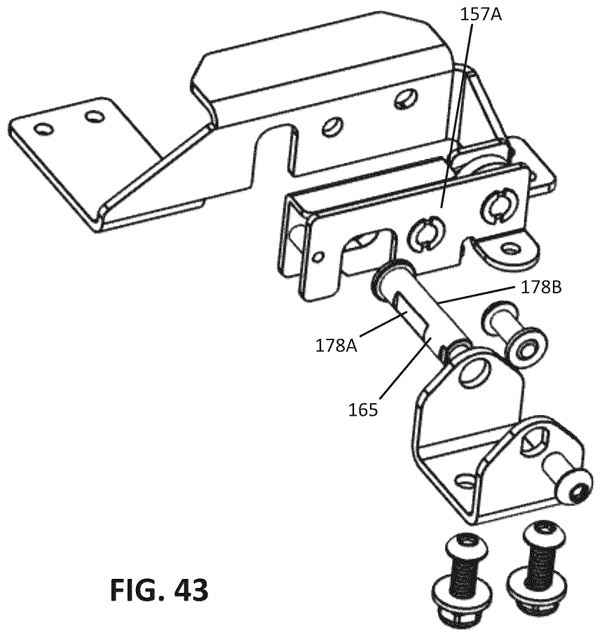

In some embodiments, the second post 165 can have a substantially cylindrical cross-section. Alternatively, the second post 165 can have an otherwise cylindrical cross-section featuring a pair of opposed flat surfaces 178A, 178B (as depicted in FIG. 43), resembling chords on opposing sides of the cylindrical cross-section. The latch assemblies 157A, 157B can operate through a catch-and-release mechanism engaging with a second post 165. The flat surfaces 178A, 178B can be designed to facilitate the operation of the latch assemblies 153A, 153B across a broader range of tolerances, such as to accommodate variations in the truck bed's shape and size.

### Lift Out Zones

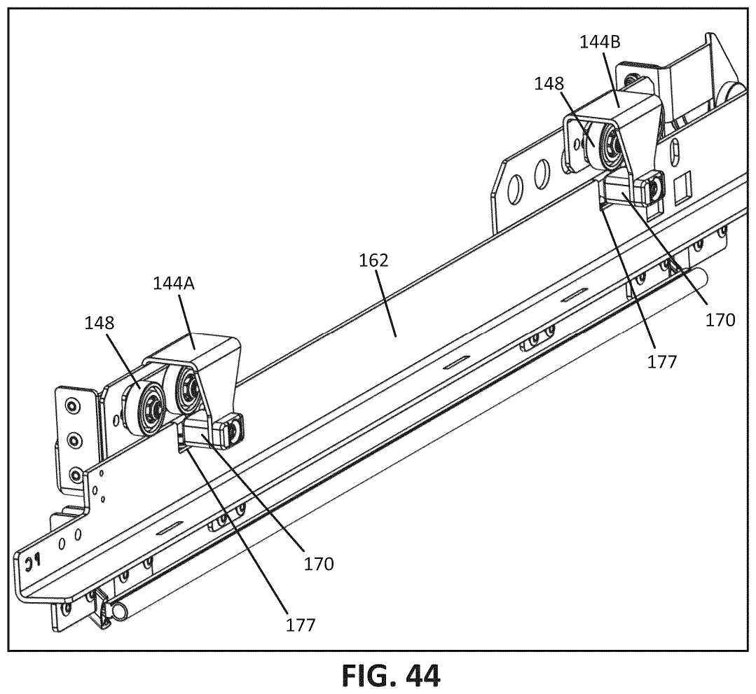

As shown in FIG. 26, the substantially rigid rail members 162 defines one or more lift out zones 177, which accommodate portions of the roller carriages 144A, 144B, 144C, and 144D of the second panel 104. These zones are specifically shaped and sized to allow bumpers 170 associated with the roller carriages 144 to pass through, facilitating the removal and reattachment of the tri-panel cover arrangement 101 from and to the rail assembly 108. The bumpers 170 are re-inserted through the cutouts 172, aligning the first and second roller wheels 146, 148 with the rail member 162 for secure reinstallation. As further depicted in FIG. 44, embodiments featuring a pair of spaced-apart bumpers 170 require these to align with similarly spaced lift out zones 177, ensuring the second panel 104 is correctly positioned along the rail assembly 108 before the cover arrangement can be detached or reattached. Some embodiments of the tonneau cover 100 allow for toolless removal of the tri-panel cover arrangement 101 from the rail assembly 108, while others may require the removal of a pin or another retention mechanism prior to detachment.

### Ornamental Design Features

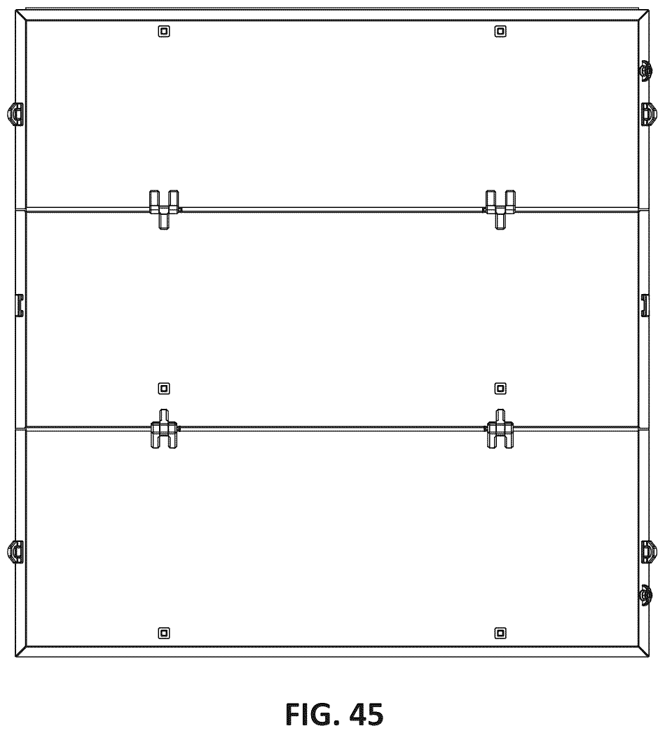

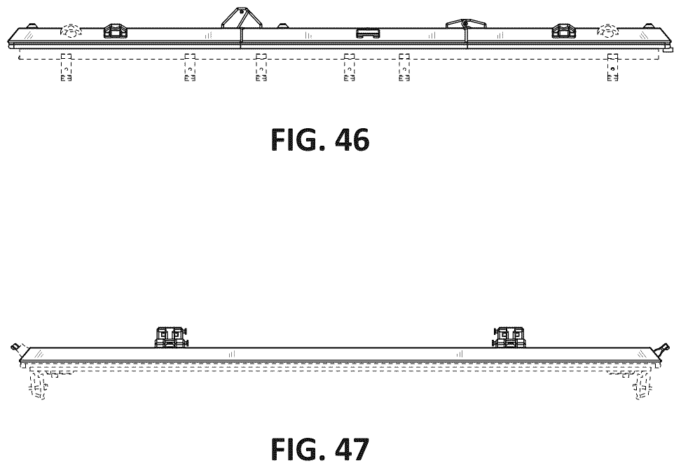

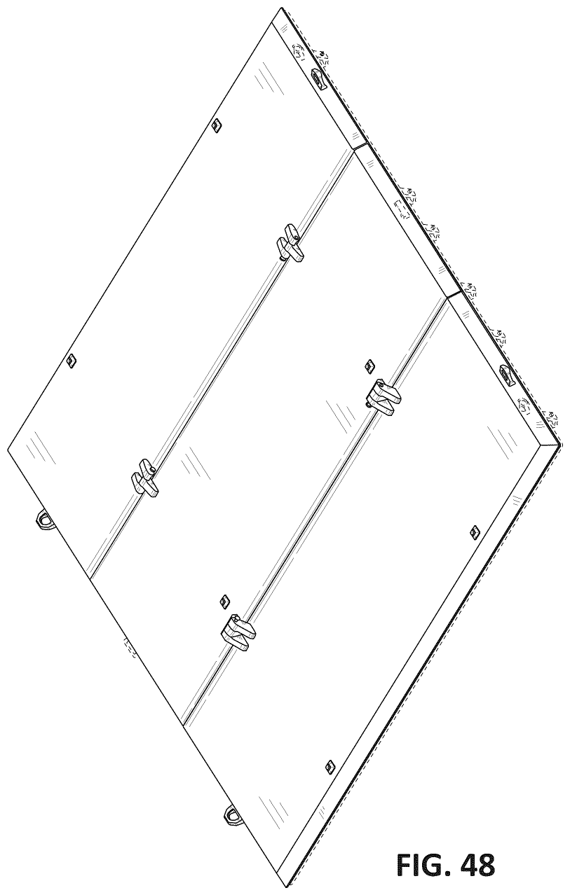

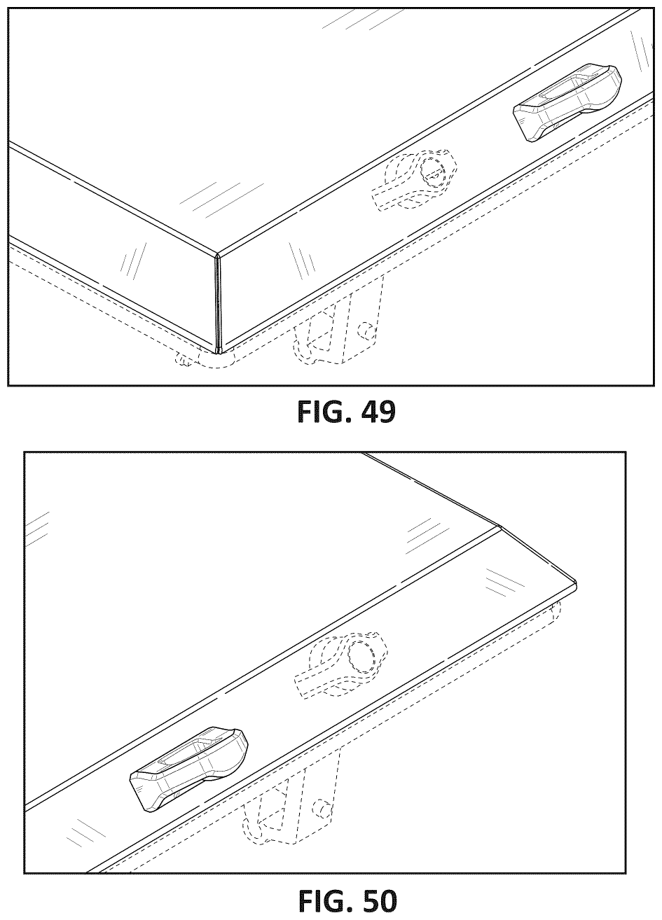

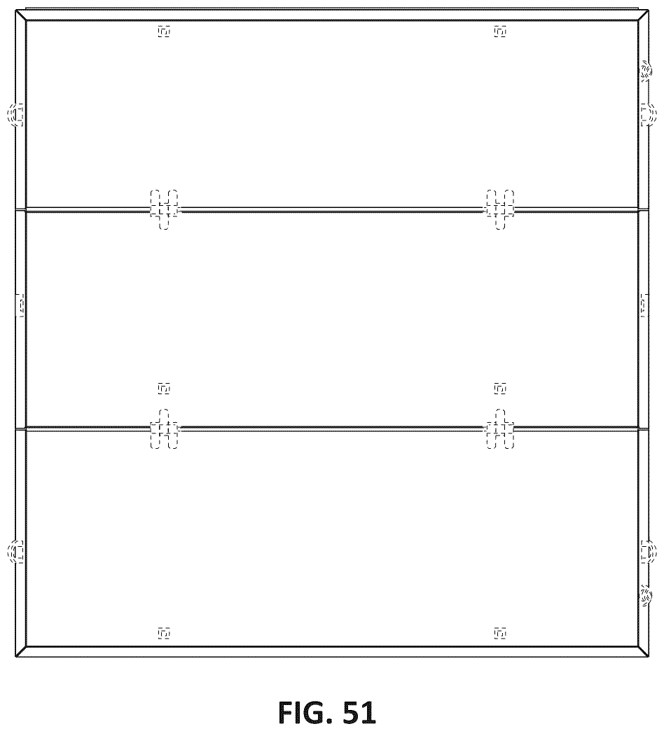

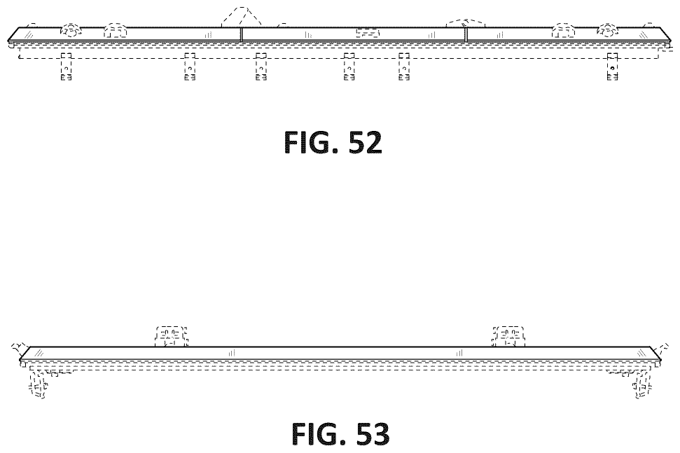

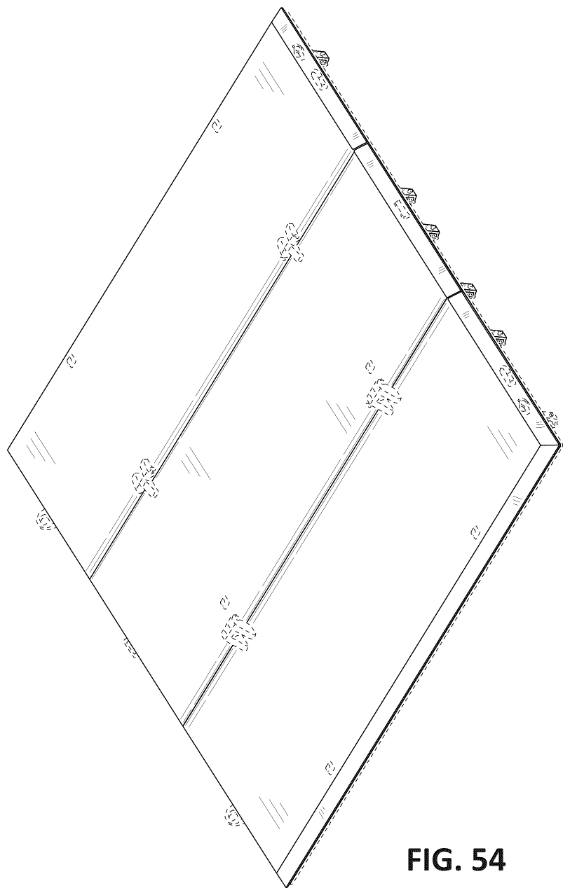

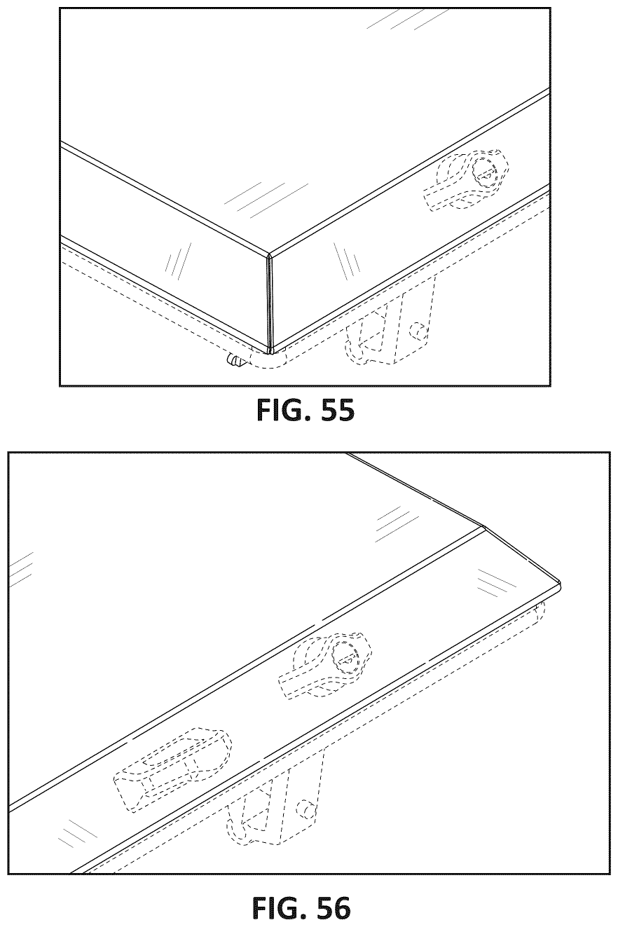

FIGS. 45-50 depict a tonneau cover design in accordance with an embodiment of the disclosure. As depicted, the tonneau cover design can include hinges, tiedowns and bumpers. FIGS. 51-56 similarly depicts the tonneau cover design of FIGS. 45-50 with the hinges, tiedowns and bumpers drawn in broken lines to emphasize the beveled edge and corners of the tri-panel cover arrangement.

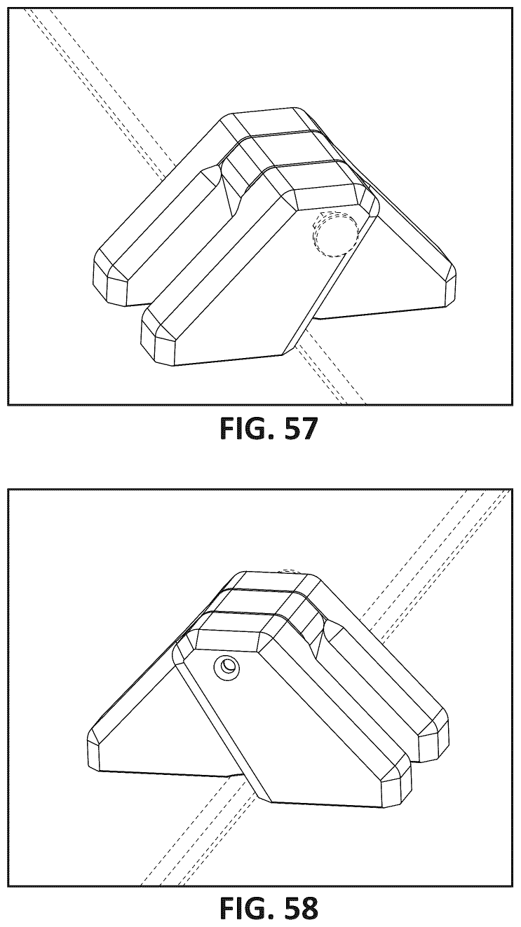

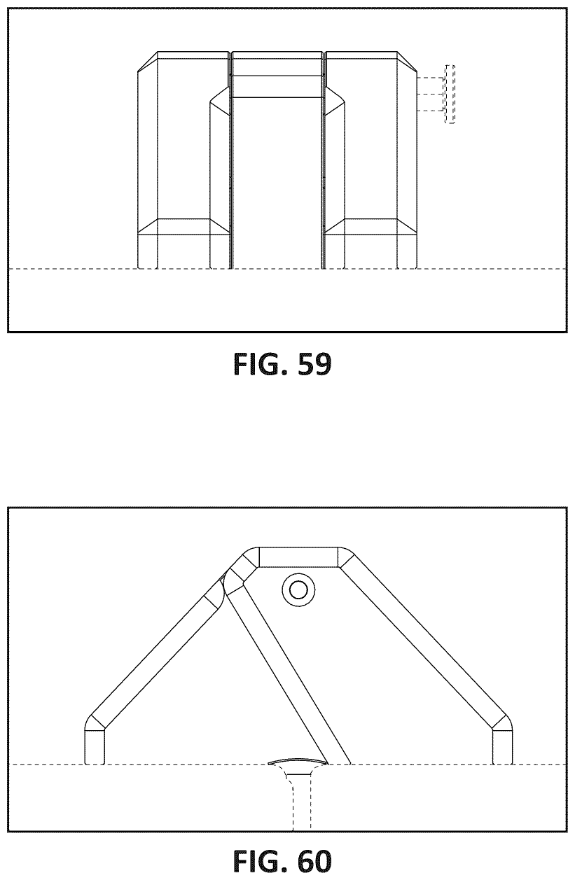

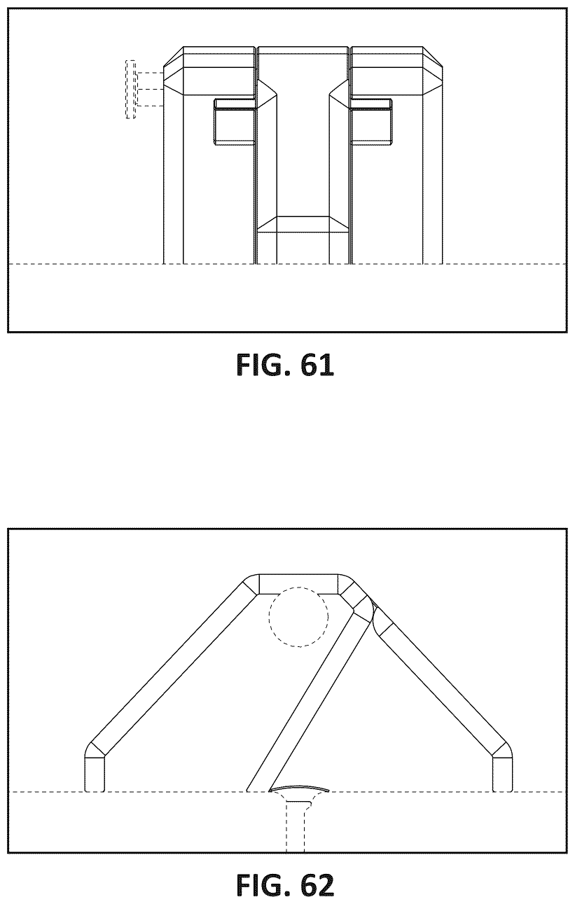

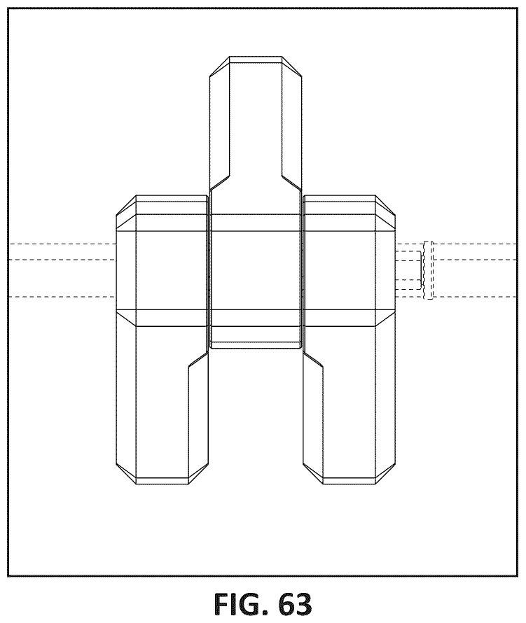

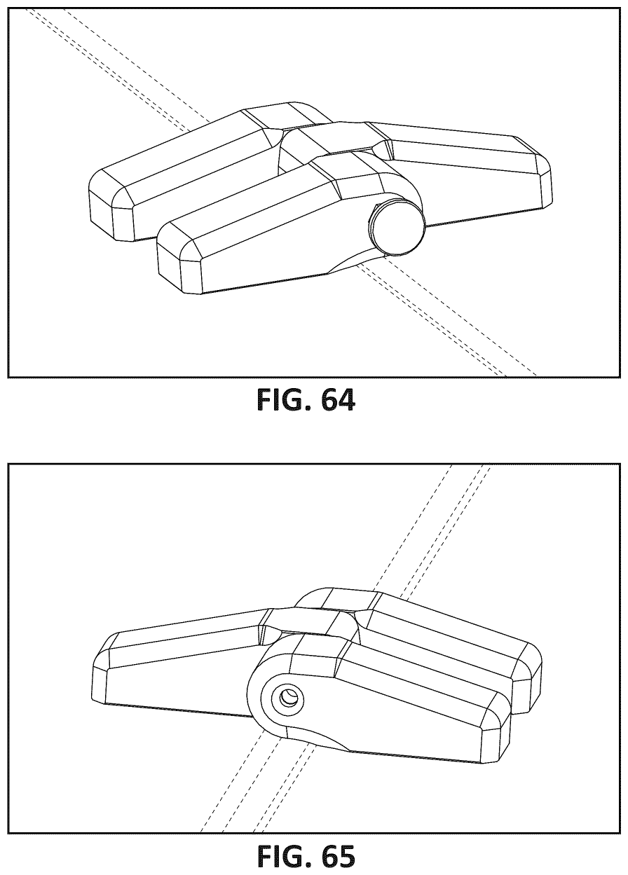

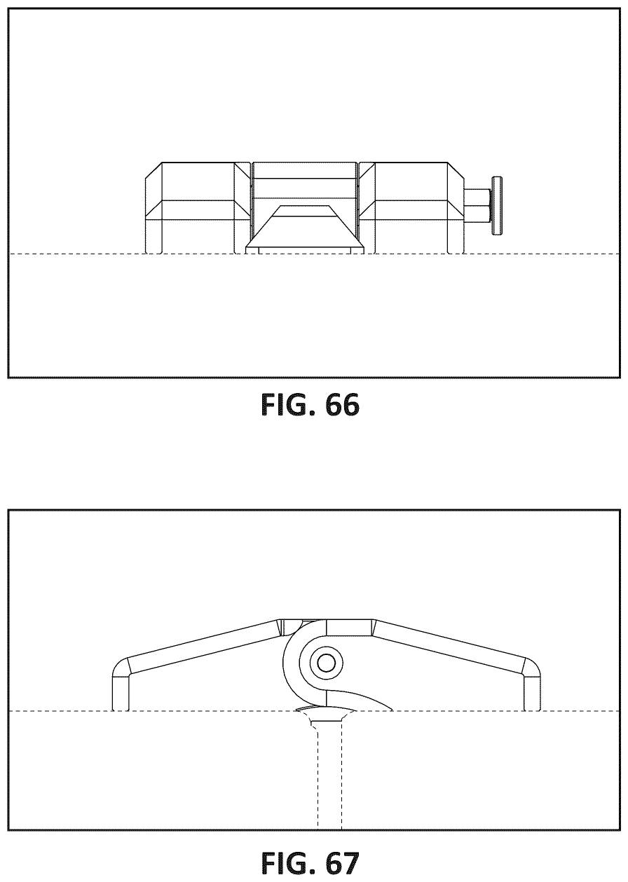

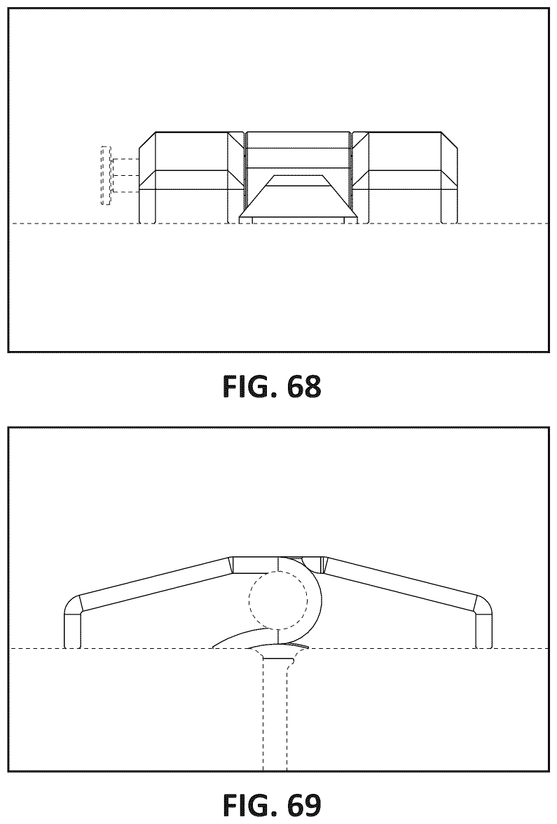

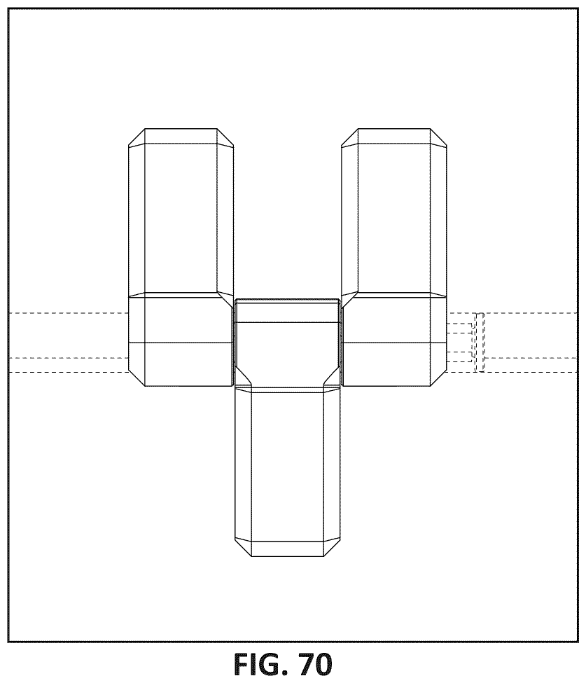

FIGS. 57-63 depict a first hinge design in accordance with an embodiment of the disclosure. FIGS. 64-70 depict a second hinge design in accordance with an embodiment of the disclosure.

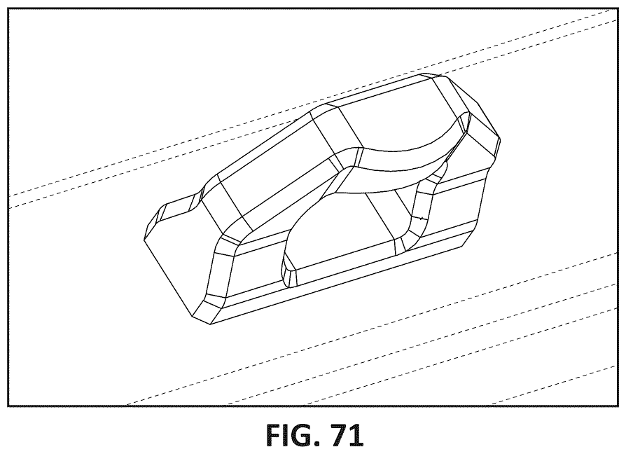

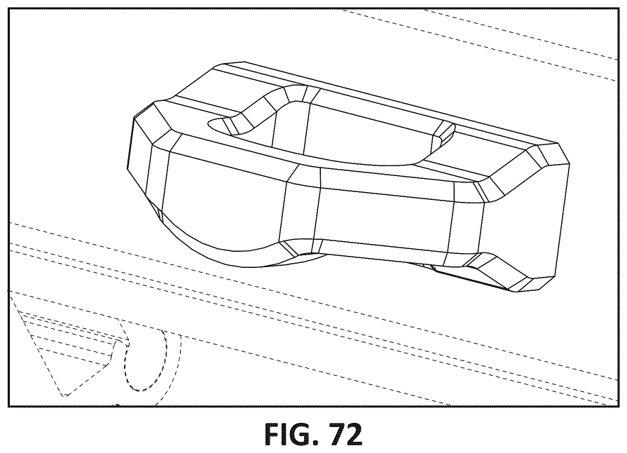

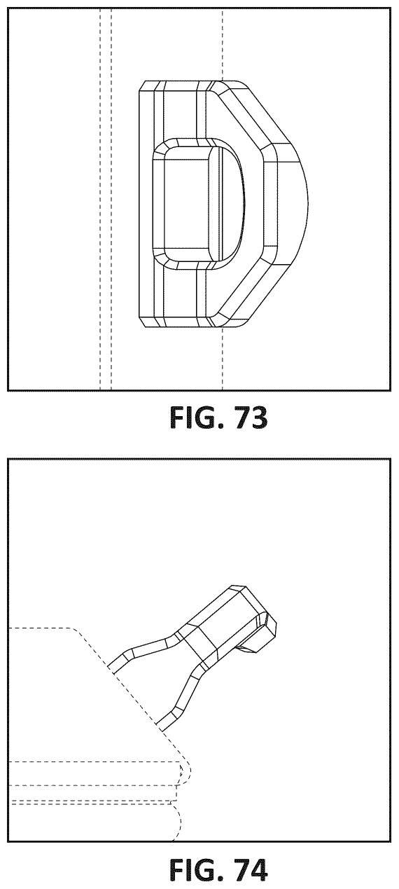

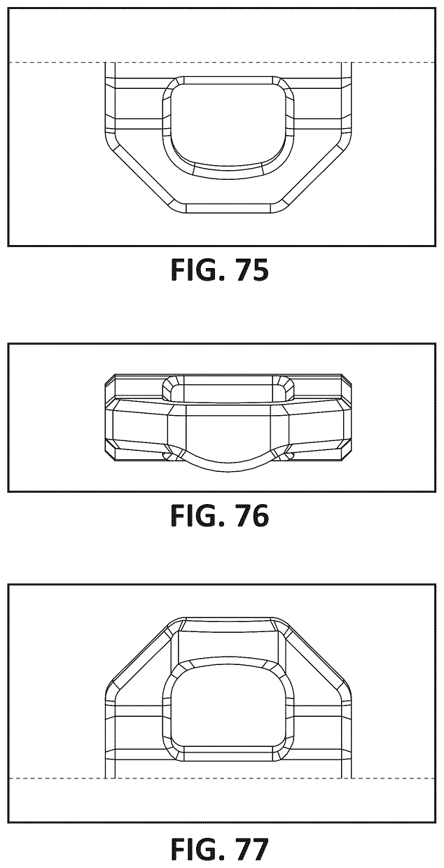

FIG. 71-77 depict a tiedown design in accordance with an embodiment of the disclosure.

### SUMMARY

Accordingly, unlike the traditional pickup truck box covers, the tonneau cover 100 features a tri-panel cover arrangement 101 comprising a first panel 102, a second panel 104, and a third panel 106. The second panel 104 is hingedly coupled between the first panel 102 and the third panel 106 and is slidably coupled to a rail assembly 108 within the truck bed, enabling the tonneau cover 100 to transition between different configurations, such as a closed configuration where the panels are positioned coplanar to one another to cover the truck bed opening, and a folded configuration where the panels are stacked atop one another. The rail assembly 108 includes features that enable the panels to drop into detents, shifting the weight to a seal between the panels and the truck bed to establish a moisture-resistant barrier. Additionally, the tonneau cover 100 incorporates water collection channels to inhibit water intrusion along the hinged edges between the panels, thereby ensuring a reliable seal and enhancing functionality while reducing complexity and maintenance requirements.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A tonneau cover, comprising:
a tri-panel cover arrangement comprising a first panel, a second panel, and a third panel, wherein the first panel is hingedly coupled to the second panel with one or more first hinges to enable the first panel to transition from a first configuration in which the first panel and the second panel are substantially coplanar to a second configuration in which the first panel is stacked on top of the second panel in an inverted configuration, and wherein the second panel is hingedly coupled to the third panel with one or more second hinges to enable the second panel to transition from the first configuration in which the second panel and the third panel are substantially coplanar to the second configuration in which the third panel is stacked on top of the first panel in an inverted configuration.

2. The tonneau cover of claim 1, wherein the one or more first hinges provides a first pivot point positioned at a first distance above a top surface of the second panel, and the one or more second hinges provide a second pivot point positioned at a second distance above the top surface of the second panel, wherein the second distance is greater than the first distance by at least a thickness of the first panel.

3. The tonneau cover of claim 1, wherein the tri-panel cover arrangement is constructed of sheet metal.

4. The tonneau cover of claim 1, wherein the first panel defines a hinge edge extending substantially orthogonal to a top surface of the first panel.

5. The tonneau cover of claim 4, wherein a bottom edge of the hinge edge is bent inwardly substantially orthogonal to the hinge edge for improved structural rigidity.

6. The tonneau cover of claim 5, wherein a first height of the hinge edge represented by a distance between the top surface and the bottom edge is less than a second height of the other edges of the first panel.

7. The tonneau cover of claim 1, wherein the second panel defines a water collection channel.

8. The tonneau cover of claim 7, wherein the water collection channel defines a hinge edge extending substantially orthogonal to a top surface of the second panel, a channel bottom extending outwardly from the hinge edge, and a side wall extending upwardly from the channel bottom to collectively form three sides of the water collection channel.

9. The tonneau cover of claim 8, wherein the water collection channel extends over a rail assembly to providing a path for removal of moisture introduced between the first panel and the second panel.

10. The tonneau cover of claim 1, further comprising a rail assembly slidably coupling at least the second panel to a truck bed, the rail assembly configured to enable the tri-panel cover arrangement to selectively slide at least one of forward or aft relative to the truck bed in a folded configuration.

11. The tonneau cover of claim 10, wherein the rail assembly defines at least two detents configured to receive at least two roller wheels operably coupled to the tri-panel cover arrangement.

12. The tonneau cover of claim 11, wherein a first spacing between the at least two roller wheels corresponds to a second spacing between the at least two detents, enabling at least partial receipt of the at least two roller wheels within the at least two detents to shift weight from one or more rollers to an edge of the tri-panel cover arrangement for improved environmental sealing.

13. The tonneau cover of claim 10, wherein at least one of the first panel or the third panel includes a latch assembly configured to selectively grip a striker element of the rail assembly.

14. The tonneau cover of claim 13, wherein the striker element defines a partially cylindrical cross-section including pair of opposed flat surfaces, enabling actuation of the latch assembly over a greater range of tolerances.

15. The tonneau cover of claim 13, wherein the latch assembly includes a first latch assembly positioned on a first side of the first panel, and a second latch assembly positioned on a second, opposite side of the first panel, and wherein at least one of a cable or linkage connects the first latch assembly to the second latch assembly enabling simultaneous action of both the first latch assembly and the second latch assembly.

16. The tonneau cover of claim 10, wherein the rail assembly defines one or more lift out zones configured to enable portions of one or more roller carriages operably coupled to the tri-panel cover arrangement to pass therethrough, enabling the tri-panel cover arrangement to be removed from or re-coupled to the rail assembly.

17. The tonneau cover of claim 1, wherein the at least one of the one or more first hinges are configured to enable removal of the first panel from the second panel, or the one or more second hinges are configured to enable removal of the third panel from the second panel.

18. The tonneau cover of claim 1, further comprising one or more tiedowns, wherein the one or more tiedowns define a curved shape including a pair of saddles configured to aid in maintaining a tautness of a tiedown strap.

19. The tonneau cover of claim 1, wherein the first panel includes a first tiedown, the second panel includes a second tiedown, and the third panel includes a third tiedown.

20. The tonneau cover of claim 1, further comprising a translation prevention mechanism configured to secure the second panel in a predetermined position along a rail assembly.

21. A tonneau cover, comprising:
a tri-panel cover arrangement comprising a first panel, a second panel, and a third panel, wherein the first panel is hingedly coupled to the second panel via a first hinge, and the second panel is hingedly coupled to the third panel via a second hinge, and wherein the second panel defines at least one water collection channel including a hinge edge extending substantially orthogonal to a top surface of the second panel, a channel bottom extending outwardly from the hinge edge, and a side wall extending upwardly from the channel bottom to collectively form three sides of the water collection channel positionable beneath at least one of the first hinge or the second hinge and extending over a rail assembly to providing a path for removal of moisture introduced between the first, the second panel, and the third panel.

22. The tonneau cover of claim 21, wherein the tri-panel cover arrangement is constructed of sheet metal.

23. The tonneau cover of claim 21, wherein the first panel defines the hinge edge extending substantially orthogonal to the top surface of the first panel.

24. The tonneau cover of claim 23, wherein a bottom edge of the hinge edge is bent inwardly substantially orthogonal to the hinge edge for improved structural rigidity.

25. The tonneau cover of claim 24, wherein a first height of the hinge edge represented by a distance between the top surface and the bottom edge is less than a second height of the other edges of the first panel.

26. A tonneau cover, comprising:
a tri-panel cover arrangement comprising a first panel, a second panel, and a third panel, wherein the first panel is hingedly coupled to the second panel via a first hinge, and the second panel is hingedly coupled to the third panel via a second hinge; and
a rail assembly slidably coupling at least the second panel to a truck bed to enable at least the second panel to selectively slide at least one of forward or aft relative to the truck bed.

27. The tonneau cover of claim 26, wherein the rail assembly defines one or more detents configured to enable shifting of weight from one or more rollers to an edge of the tri-panel cover arrangement for improved environmental sealing.

28. The tonneau cover of claim 26, wherein at least one of the first panel, the second panel or the third panel includes a latch assembly configured to selectively grip a portion of the rail assembly.

29. The tonneau cover of claim 28, wherein the latch assembly includes a first latch assembly positioned on a first side of at least one of the first panel, the second panel or the third panel, and a second latch assembly positioned on a second, opposite side of the first panel, the second panel or the third panel, and wherein at least one of a cable or linkage connects the first latch assembly to the second latch assembly for simultaneous operation.

30. The tonneau cover of claim 29, wherein the first latch assembly and the second latch assembly are actuated both by a locking actuator member.

31. A tonneau cover, comprising:
a tri-panel cover arrangement including at least a first panel and a second panel, wherein, the first panel is hingedly coupled to the second panel with one or more first hinges to enable the first panel to transition from a first configuration, in which the first panel and the second panel are substantially coplanar, to a second configuration, in which the first panel is stacked on top of the second panel in an inverted configuration; and
a rail assembly slidably coupling at least the second panel to a truck bed to enable at least the second panel to selectively slide relative to the truck bed, wherein the first panel includes one or more hooks configured to pivot into engaging contact with the rail assembly when the first panel is transitioned to the first configuration to restrict vertical movement of the tri-panel cover arrangement relative to the rail assembly.

32. The tonneau cover of claim 31, wherein the rail assembly defines one or more detents configured to enable shifting of weight from one or more rollers operably coupled to the second panel to an edge of the tri-panel cover arrangement.

33. The tonneau cover of claim 31, wherein at least one of the first panel, the second panel or a third panel includes a latch assembly configured to selectively grip a portion of the rail assembly.
